(19) United States
(12) Patent Application Publication
(10) Pub. No.: US 2002/0184504 A1
(43) Pub. Date: Dec. 5, 2002

(54) Combined digital signature

(76) Inventor: Eric Hughes, Berkeley, CA (US)

Correspondence Address: Eric Hughes, 1577 Rose Street, Berkeley, CA, 94703, US

(21) Appl. No.: 09/817,670

(22) Filed: Mar. 26, 2001

(51) Int. Cl. H04L 9/00

(52) U.S. Cl. 713/177; 713/176

(57) ABSTRACT

A combined digital signature is method of making a single public key digital signature on a number of messages, such that individual combined signatures may be extracted and individually presented. The mechanism of a combined digital signature is a combination of a hash tree whose leaves correspond to messages, together with a cryptographic signature made on the root of that hash tree. The invention comprises a method of making a combined signature, a method of extracting individual combined signatures, a method of verifying individual combined signatures, and the data format of an individual combined signature. The invention can increase performance of signature-making by a factor of several hundred over previous art.

### BACKGROUND

1. Field of the Invention

The present invention relates generally to methods and apparatuses for generating digital signatures. More specifically, the invention relates to systems, methods, and data structures that provide efficient and cost-effective generation of digital signatures for servers that participate in many transactions simultaneously and which require tens of thousands of signatures per second.

2. Description of the Related Art

The recent explosion of Internet e-commerce has led to a corresponding demand for security and authentication in online interactions. Digital signatures using public-key cryptography are the most widely used mechanism for secure authentication. Digital signatures are at the core of widespread connection-oriented protocols such as SSL, TLS, and SSH. In each of these cases, the digital signature is used to establish a firm basis of identity before proceeding on with the connection.

Connection-oriented protocols have proven the efficacy and utility of digital signatures. These protocols, however, are relatively light users of digital signatures. Each side identifying themselves makes a signature to allows a receiver to identify data received from that connection. Nevertheless, the total signature load generated in typical web server is too great to support without special assistance. A typical such server can process hundreds of simultaneous connections. A moderately loaded server now has hundreds of digital signatures to make per second. This level of signature load is beyond the capacity of standard CPU's.

The current state of the art in dealing with this burdensome computational load are cryptographic co-processors. Some of the most best-known manufacturers of these devices are nCipher, IBM, and Rainbow Technologies. The current practice is as follows: an application (such as a web server) requests a digital signature from an internal software proxy that forwards the request to the special hardware accelerator for processing; the results are remitted back to the application. Current practice for accelerating signatures is entirely typical of any other computational co-processor.

This practice has just sufficed for the current generation of connection-oriented security protocols. Other protocols, however, have not fared so well, largely because they are much heavier users of digital signatures. The most notable example of this kind is SET, the suite of credit card payment processing protocols. SET is a heavy user of digital signatures. It is a multi-party protocol, with each party signing multiple messages in each protocol session. Furthermore, an acquiring bank has an especially concentrated load. Suppose each merchant has, say, dozens of simultaneous purchasers at their web site. The larger acquiring banks have hundreds of online merchants and need to support thousands or tens of thousands of simultaneous purchase transactions. Hardware accelerators do not scale well enough to support this application. Instead of a single hardware accelerator, large banks of hardware accelerators would have to be used. This has not proven feasible.

SET was announced in 1996, and its precursor protocols, SEPP and STT, were themselves announced in 1994. SET has the backing of both MasterCard and Visa, and many top cryptographers have worked on the protocol and had the opportunity to examine it. Since this work began, the issue of digital signature load has only been addressed through hardware acceleration. Given the ubiquity of credit card use and the amount of spending and talent that has gone into the SET initiative, the failure of the designers and cryptographers working on SET to create a scalable digital signature is notable. SET has been around a number of years, and there is a long-felt but unsolved need in the market for new systems and new methods for digital signatures that provide adequate performance for these kinds of applications.

In light of the foregoing, it would be useful to have a means of making digital signatures at the high rates needed to support sophisticated electronic commerce applications. Ideally, the core mechanism would embody an algorithmic change from current practice, since algorithmic efficiency dominates performance concerns. An incrementally faster hardware accelerator cannot offer the same throughput increases as can a redesign around an appropriate algorithm.

Typical cryptographic practice presumes that each signature is performed one at a time. The goal then is to make each signature operation faster. The speed of these hardware accelerators is limited by fundamental computational delays. Accordingly, it would be useful if it were possible to perform multiple signatures simultaneously, leveraging the computational capacity of existing hardware.

Prior Patented Art

The prior art in digital signatures is extensive. It began with the pioneering work of Diffie, Hellman, and Merkle. Early in the field, two fundamental approaches to digital signatures were developed. The best known approach, namely, public key cryptography, is exemplified in U.S. Pat. No. 4,200,770 “Cryptographic apparatus and method” (Hellman, Diffie, Merkle) and U.S. Pat. No. 4,218,582 “Public key cryptographic apparatus and method” (Hellman, Merkle). These public key algorithms were the original inspiration for all the subsequent work that has followed.

The other approach to digital signatures, less used but still powerful, is that of hash trees, as demonstrated in U.S. Pat. No. 4,309,569 “Method of providing digital signatures” (Merkle) and U.S. Pat. No. 4,881,264 “Digital signature system and method based on a conventional encryption function” (Merkle). These two approaches both implement the concept of the digital signature. Nevertheless, the two approaches each have their own strengths and weaknesses.

Both public key signatures and hash tree signatures each have unique verifying data that is necessary to verify a signature. With public key signatures, this verifying data is a public key. With hash tree signatures, the verifying data is the root of a hash tree. These verifying data do not identify the maker of a signature in isolation. The verifying data are purely technical instruments. They do, however, provide a point of reference about the signature that may allow the maker to be identified, given other information.

This other information is an assertion that a named maker of signatures is linked to particular verifying data. A cryptographic signatures that verifies correctly against stated verifying data may be presumed to originate from the named maker. A verifying party relies upon trustworthy public dissemination of this linking data to identify the maker of a signature. Without a linkage between verifying data and the name of a maker, neither cryptographic signature mechanism can possibly function as means of digital identification, much less as a digital signature.

In both kinds of cryptographic signatures, both for public key and for hash tree signatures, the verifying data is compared against a message and a signature itself. A suitable verification algorithm, which depends upon the particular signature scheme, determines technical integrity of a signature. Then, after examining the linkage between a named maker and the verifying data, a verifier can learn the identity of the maker of a signature. Both kinds of cryptographic signature use this basic structure. The key difference between them is at what point a signature can first be used to identify a maker.

The advantage of public key schemes is that linking data can be distributed before signature verification. Verification of a public key signature may occur immediately upon presentation. In contrast, hash tree signatures become verifiable only after construction of a tree and publication of its root. The difference, though insignificant in many applications, is critical for real-time uses, e.g. remote login and transaction authorization. The latency inherent in the construction and publication of hash tree roots eliminates the possibility of real-time operation. It would therefore be useful to capture the advantage of real-time operation that public key signature schemes afford.

On the other hand, hash tree signatures are enormously more computationally efficient than are any known, secure public key systems. As a rule of thumb, a single public key signature takes about as long as one-thousand to ten-thousand hash function computations of similar size and security. (The exact ratio varies widely, depending upon choices of algorithm, security model, cryptographic parameters, and means of implementation.) Hash tree signature methods yield one signed message for every one or two hash function computations (depending on the particular tree structure chosen). Thus the performance difference is tremendous. It would therefore be useful to capture the performance advantage of hash tree signature methods.

Related Patented Art

The inventive progeny of the hash tree signatures of U.S. Pat. Nos. 4,309,569 and 4,881,264 are numerous. The basic hash tree concept has also been applied in numerous inventions in diverse areas of security, including ciphers, message authentication codes, secure channels, key management, public key infrastructure, identification, user authentication, time-stamping, document authenticity, digital rights management, trusted computing bases, secure boot, spread spectrum, and data compression. Relatively few of these inventions, however, are about making digital signatures proper. Instead, the technology of the hash tree has been applied to numerous other cryptographic techniques, very few of them for making signatures. The following is a review of the closest other work involving hash trees and digital signatures as they relate to making digital signatures.

U.S. Pat. No. 5,754,659 “Generation of Cryptographic Signatures Using Hash Keys” (Sprunk, Moroney, Candelore) discloses a straightforward application of the hash tree concept to prior art for access control in broadcast environments. As in the original hash tree work, U.S. Pat. No. 5,754,659 uses a hash tree to combine multiple data elements. Yet the multiple data elements so combined are not documents to be signed, anticipating separate verification of the signatures. Instead, data elements are combined to implement an access control system suitable for protection of broadcast content. U.S. Pat. No. 5,754,659 transmits a single signature over a broadcast channel. This invention does not anticipate transmitting separate signatures to individual parties. It would be useful to have a system that signed individual messages from disparate sources and separated out those signatures for individual transmission.

A complementary analogue to making digital signatures is found in U.S. Pat. No. 5,347,581 “Verification process for a communication system” (Naccache, M'Raihi). The invention disclosed in U.S. Pat. No. 5,347,581 is a system for simultaneous verification of signatures. A number of signatures are made on the client side, presumably by a number of different parties. A server simultaneously verifies all these signatures with a single operation. It would be useful to have a system for simultaneously making a number of signatures, complementing one that could simultaneously verify a number of signatures made separately.

U.S. Pat. No. 5,781,629 “Digital document authentication system” (Haber, Stornetta) describes a system for making timestamps on digital documents. To use a hash tree signature as a means of identification, one has to publish a link between the verifying data of the hash tree and the maker of a signature. The invention disclosed in U.S. Pat. No. 5,781,629, instead of publishing identifying information, publishes instead a connecting link between the verifying data and some temporal data concerning the time a document was received. This invention authenticates the existence of a document at the current time, rather than the identity of its maker. While this is a perfectly reasonable use of the word “authentication”, the more common use is related to identification of persons, which this invention is not concerned with. It would be useful to apply the basic hash tree signature to identification, rather than to temporality.

The hash tree signature method has a security hazard when practiced in the context of a signature server. A signature server receives a number of messages to be signed. If a hash tree is constructed naively, the message to be signed could itself have been constructed as the root of a separate hash tree. The signature obtained from the engine could then be extended. Whereas the server thought it was signing only the single message it received, it might have effectively been signing hundreds of converted signatures. The attack against this vulnerability is called a “tree extension” attack. It would be useful to have techniques for guarding against tree extension attacks.

In view of the foregoing, it would be useful to apply the original work of Merkle to construction of faster methods of making digital signatures with the verification properties of public key signatures. This lacuna in the art is surprising, particularly in light of the immediate commercial opportunity such an invention would present.

### SUMMARY

In accordance with the present invention, a combined signature is a hash tree constructed from a sequence of messages combined with a conventional public key signature made upon the root of the hash tree.

Objects and Advantages

In addition to the objects and advantages of the combined digital signature as described in this patent, several objects and advantages of the present invention are as follows:

a) to provide a means of making digital signatures hundreds of times faster than conventional public key signatures;

b) to provide a common facility for making digital signatures that a number of simultaneously running programs within a single computer can use;

c) to provide a common facility for making digital signatures that a number of computers on a network can use to request and receive signatures over that network;

d) to provide a common facility for making digital signatures that can provide enough total throughput to support individually signed messages, complex network protocols, and multiple simultaneous servers, each with multiple simultaneous connections; and

e) to provide a means of making digital signatures that guards against conversion of the resulting signature into some other signature.

Further objects and advantages will become apparent in the ensuing descriptions and drawings.

### DRAWINGS

Figures

FIG. 1 shows an illustrative combined signature tree for thirteen messages, a hash tree with leaves generated by those thirteen messages, and a public key signature at the top.

FIG. 2 shows an illustrative pruned signature tree, a sub-graph of FIG. 1, which is a minimal sub-tree for an individual combined signature.

FIG. 3 shows an illustrative individual combined signature.

FIG. 4 show a reconstructed verification tree, which was reconstructed from the signature of FIG. 3.

FIG. 5 shows some of the notation used in the Figures.

FIG. 6 show a specification for a class of left-balanced binary trees.

FIG. 7 shows a specification for a class of position-dependent hash trees.

FIG. 8 shows a specification for a set of formatting functions.

FIG. 9 shows a specification for the nodes of a combined signature tree.

FIG. 10 shows a specification a class of combined signature trees.

FIG. 11 shows a specification for a set of padding functions.

FIG. 12 shows a specification for a subset of nodes that comprise an extracted signature tree from a complete combined signature tree.

FIG. 13 shows a specification for a presentation of a signature node-set for transmission to another party.

FIG. 14 shows a specification of a predicate that defines validity of an extracted individual combined signature.

FIG. 15 shows a block diagram of a device that accepts a message sequence and a message selection and outputs an individual combined signature.

FIG. 16 shows a block diagram of a device that accepts an individual combined signature, a message, and a public key and outputs “valid” or “invalid”.

FIG. 17 shows a flowchart for an algorithm that constructs a combined signature tree from a set of messages, a set of padding bits, and a private key.

FIG. 18 shows a flowchart for an algorithm that verifies an individual combined signature relative to a message and a public key.

FIG. 19 shows an illustrative timing diagram that shows an exemplary excerpt of the activities of a continuously running signing device.

FIG. 20 shows a state machine for a hash tree constructor as shown in FIG. 15.

FIG. 21 shows a state machine for a root node signer as shown in FIG. 15.

FIG. 22 shows a state machine for a signature extractor as shown in FIG. 15.

FIG. 23A shows a variant of a combined signature tree with an additional “salt” node.

FIG. 23B shows a sample of variant definitions for the use of salted hash functions.

FIG. 24 shows a variant definition of a node formatting function.

FIG. 25 shows another variant definition of a node formatting function.

FIG. 26A shows a variant of a combined signature tree with a leaf layer separate from a message layer.

FIG. 26B shows a sample of variant definitions for the use of separate leaf and message layers.

FIG. 27 shows a variant signature start tag for an individual combined signature.

FIG. 28 shows a variant pair of verification trees.

FIG. 29 shows a sample of variant definitions of extracted signature validity.

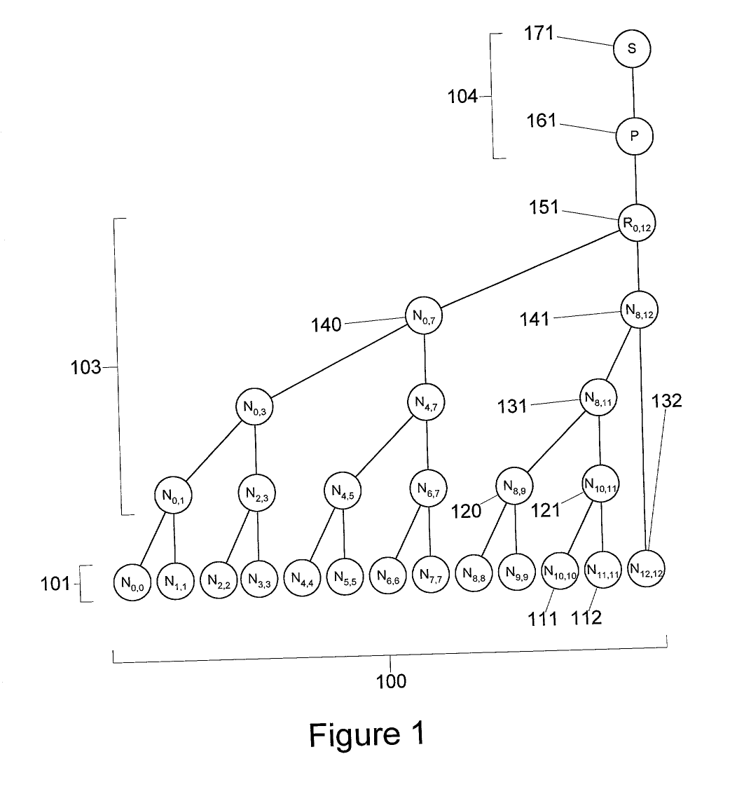

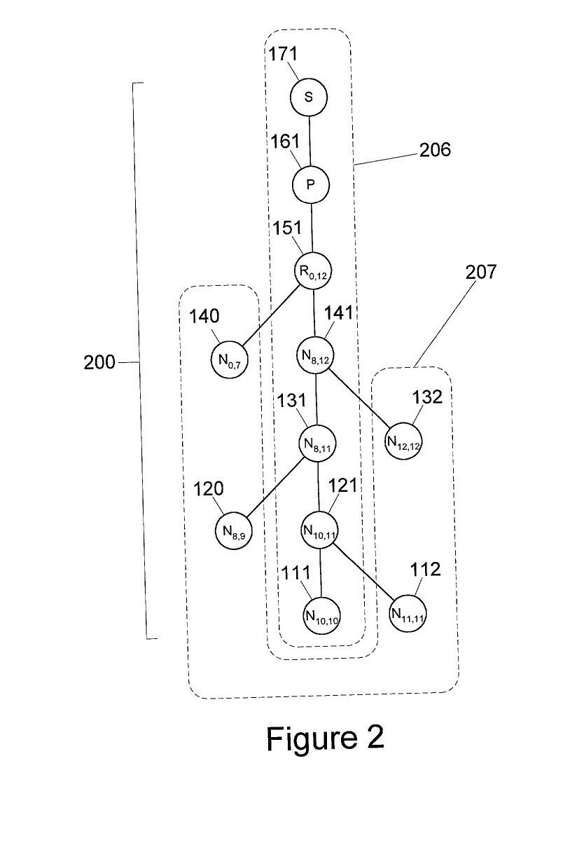

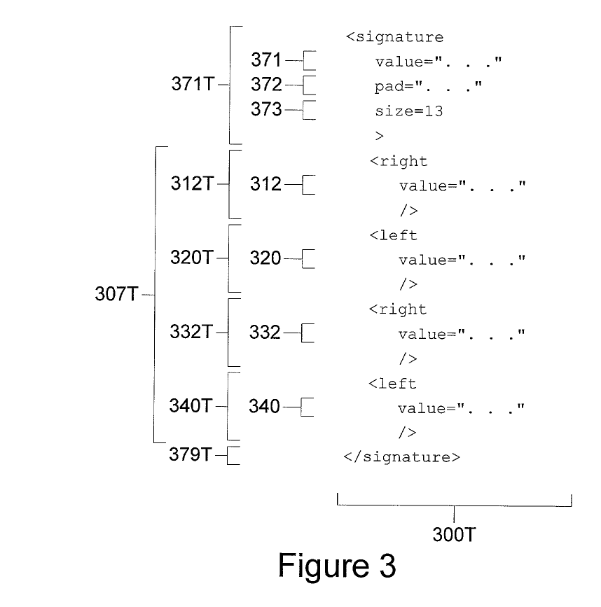

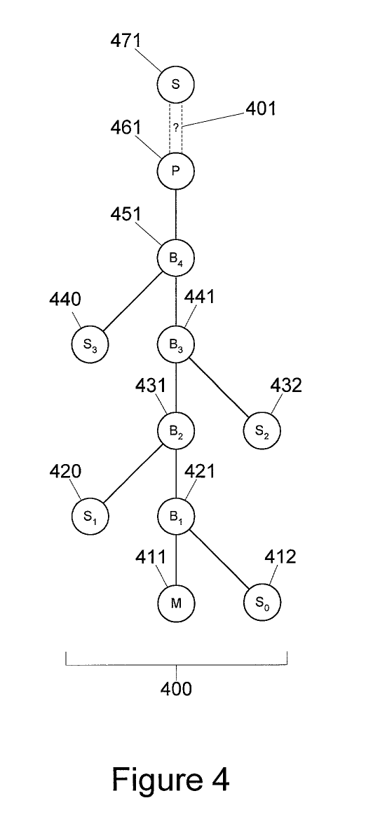

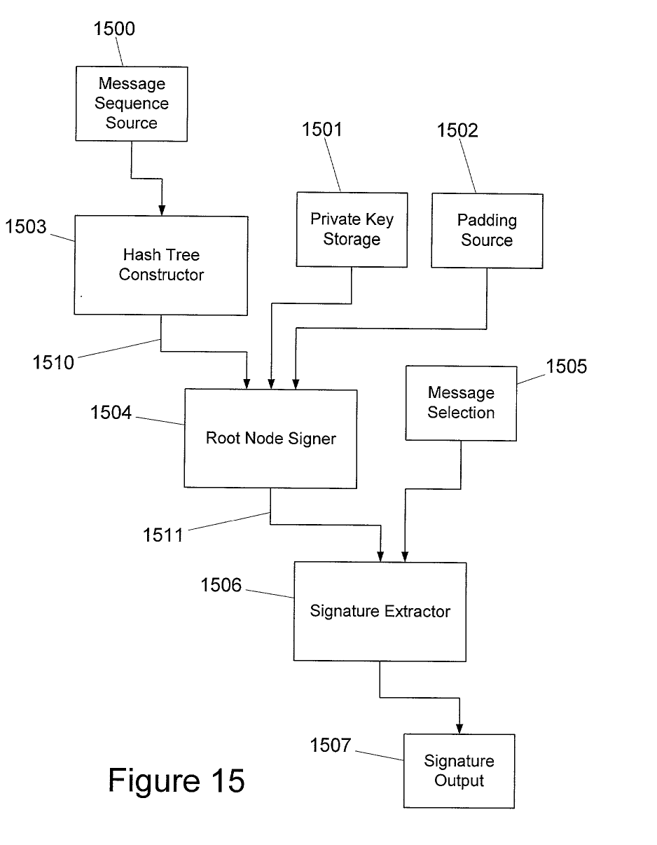

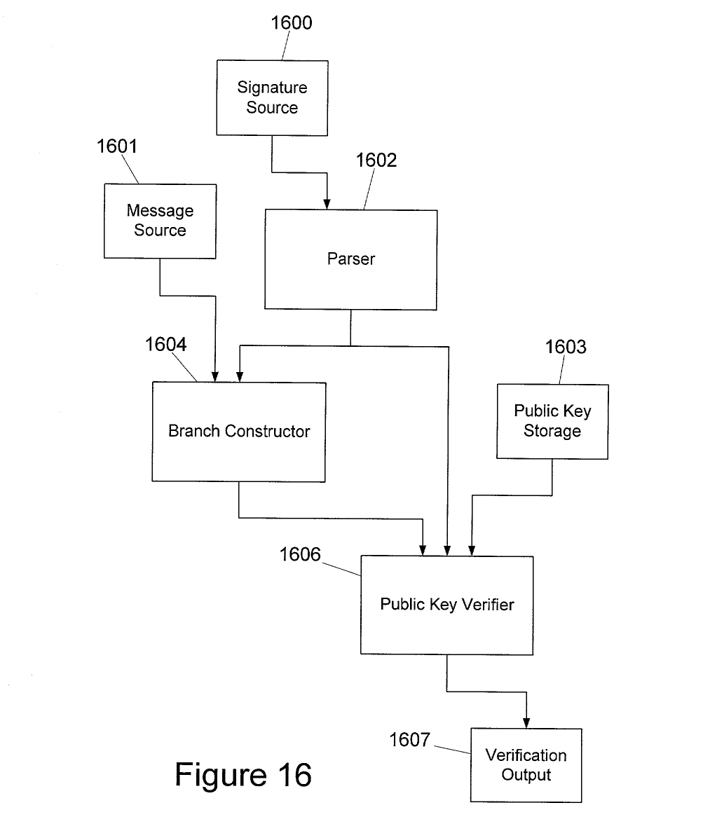

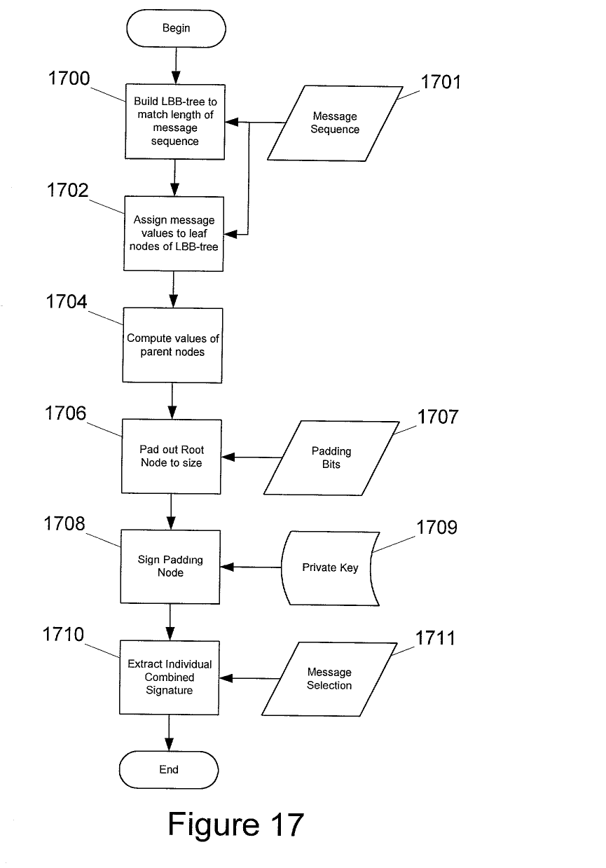

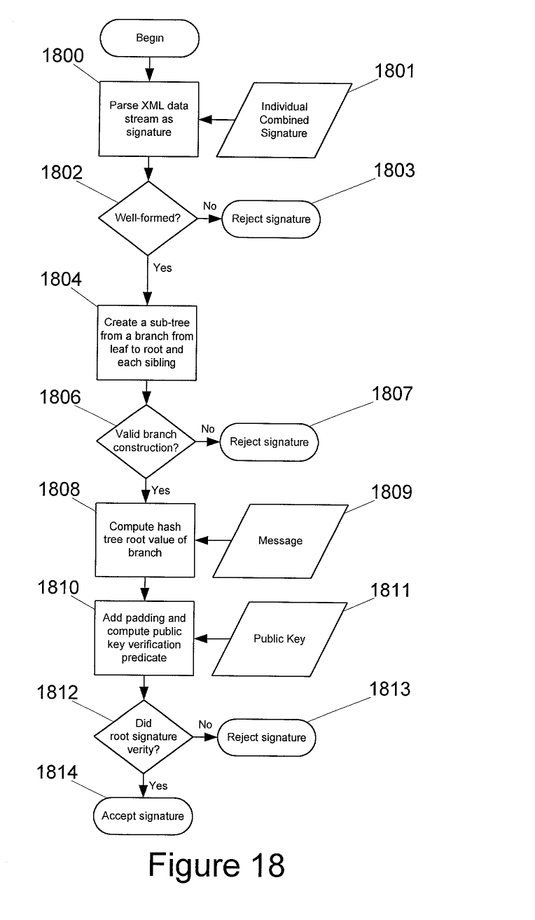

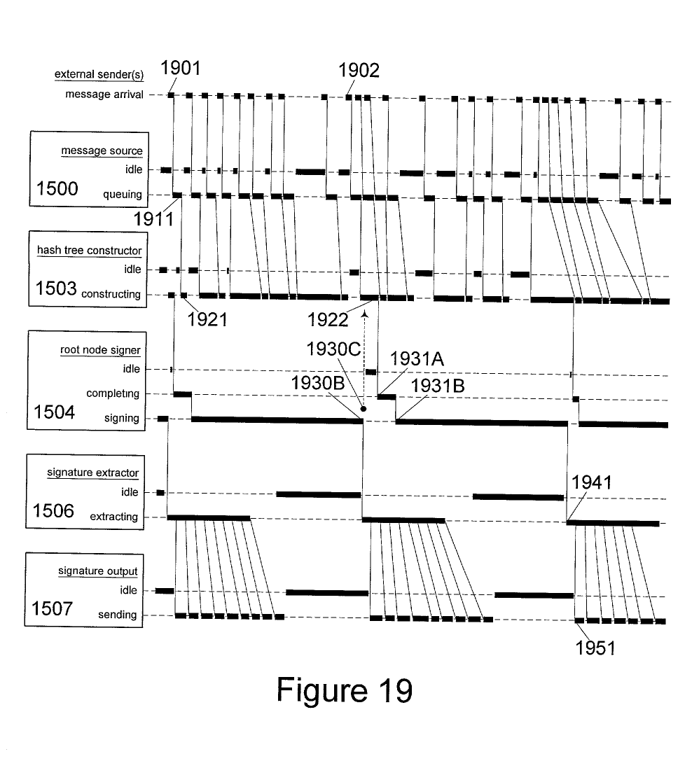

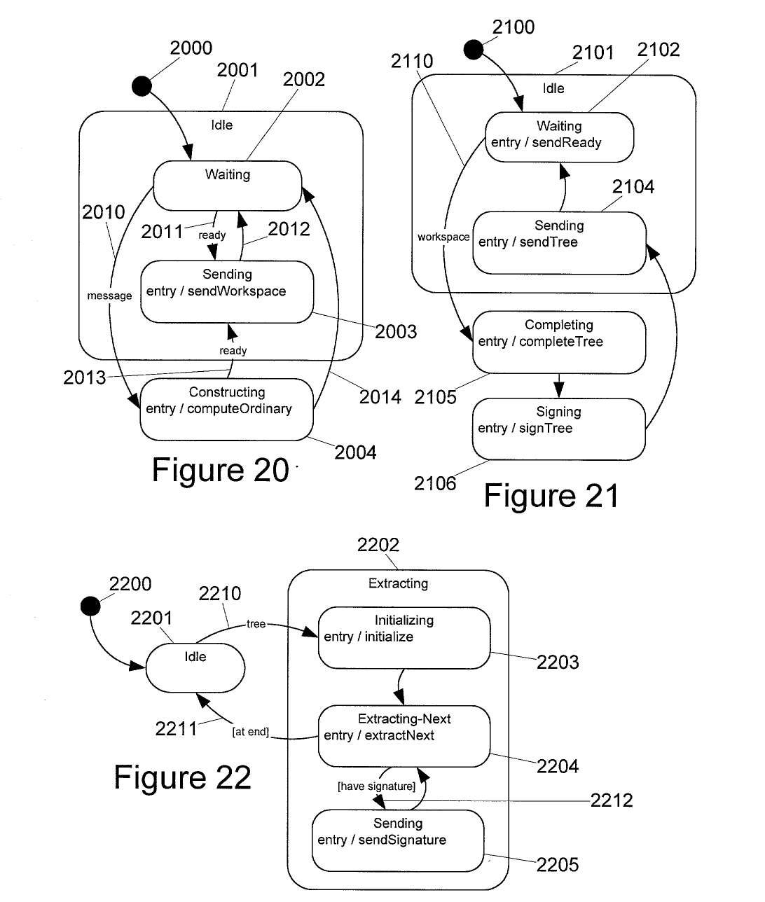

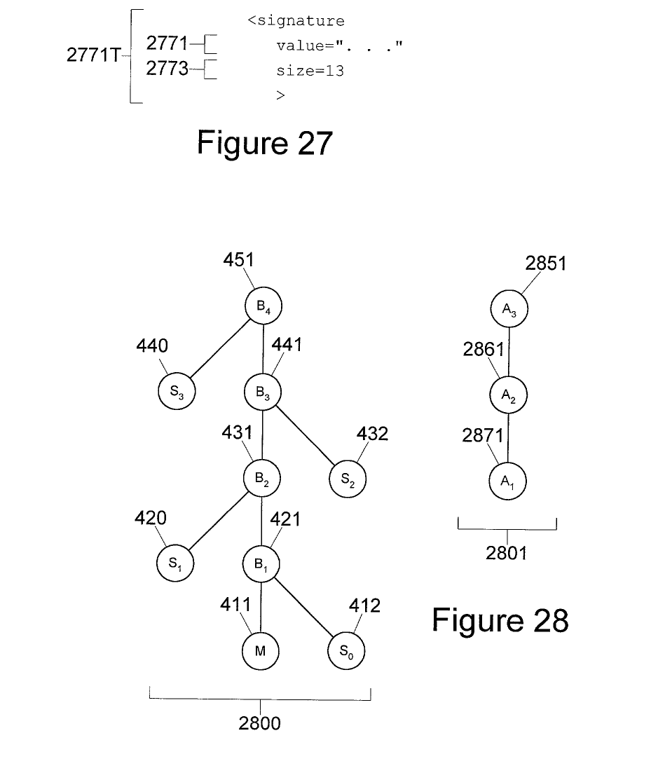

List of Reference Numerals

| FIG. 1 | | 320T. | Left sibling tage for node |
|---|---|---|---|
| 100. | Combined signature tree | | 8, 9 |
| 101. | Leaf node layer | 332. | Attribute value of node |
| 103. | Parent node layer | | 12, 12 |
| 104. | Public key signature | 332T. | Right sibling tag for node |
| | layer | | 12, 12 |
| 111. | Leaf node 10, 10 | 340. | Attribute value of node 0, 7 |
| 112. | Leaf node 11, 11 | 340T. | Left sibling tag for node |
| 120. | Node 8, 9 | | 0, 7 |
| 121. | Node 10, 11 | 371. | Attribute value of signature |
| 131. | Node 8, 11 | 371T. | Signature start tag |
| 132. | Leaf Node 12, 12 | 372. | Attribute pad for hash tree |
| 140. | Node 0, 7 | | root |
| 141. | Node 8, 12 | 373. | Attribute size of tree |
| 151. | Root node 0, 12 | 379T. | Signature end tag |
| 161. | Padding node | FIG. 4 | |
| 171. | Signature node | 400. | Verification tree |
| FIG. 2 | | 401. | Candidate signature edge |
| 200. | Pruned signaure tree | 411. | Message node |
| 206. | Signature branch | 412. | Sibling node 0 |
| 207. | Siblings of branch | 420. | Sibling node 1 |
| FIG. 3 | | 421. | Branch node 1 |
| 300T. | Individual combined | 431. | Branch node 2 |
| | signature | 432. | Sibling node 2 |
| 307T. | Sibling tags section | 440. | Sibling node 3 |
| 312. | Attribute value of nodes | 441. | Branch node 3 |
| | 11, 11 | 451. | Hash tree root node |
| 312T. | Right sibling tag for node | 461. | Padding node |
| | 11, 11 | 471. | Signature node |
| 320. | Attribute value of node | FIG. 15 | |
| | 8, 9 | 1500. | Message sequence source |
| 1501. | Private key storage | 1711. | Message selection |
| 1502. | Padding source | FIG. 18 | |
| 1503. | Hash tree constructor | 1800. | Parsing procedure |
| 1504. | Root node signer | 1801. | Individual combined |
| 1505. | Message selection | | signature |
| 1506. | Signature extractor | 1802. | Good-form test |
| 1507. | Signature output | 1803. | Signature rejection |
| 1510. | Hash tree signal | 1804. | Verification subtree |
| 1511. | Combined signature tree | | construction |
| | signal | 1806. | Valid branch test |
| FIG. 16 | | 1807. | Signature rejection |
| 1600. | Signature source | 1808. | Root value calculation |
| 1601. | Message source | 1809. | Message |
| 1602. | Parser | 1810. | Public key verification |
| 1603. | Public key storage | 1811. | Public key |
| 1604. | Branch constructor | 1812. | Verification check |
| 1606. | Public key verifier | 1813. | Signature rejection |
| 1607. | Verification output | 1814. | Signature acceptance |
| FIG. 17 | | FIG. 19 | |
| 1700. | LBB-tree construction | 1901. | First message input |
| | procedure | 1902. | Tenth message input |
| 1701. | Message sequence | 1911. | Queuing activation |
| 1702. | Leaf valuation procedure | 1921. | First tree increment |
| 1704. | Tree valuation procedure | | activation |
| 1706. | Padding procedure | 1922. | Tenth tree increment |
| 1707. | Padding bits | | activation |
| 1708. | Private key signature | 1930B. | Signing tree activation |
| | operation | 1930C. | Coordination signal |
| 1709. | Private key | 1931A. | Tree completion activation |
| 1710. | Extraction procedure | 1931B. | Signing tree activation |
| 1951. | Sending activation | 1941. | Extraction activation |
| FIG. 20 | | FIG. 22 | |
| 2000. | Initial state | 2200. | Initial state |
| 2001. | Idle state | 2201. | Idle state |
| 2002. | Waiting state | 2202. | Extracting state |
| 2003. | Sending state | 2203. | Initializing state |
| 2004. | Constructing state | 2204. | Extracting-Next state |
| 2010. | Message transition | 2205. | Sending state |
| 2011. | Ready transition | 2210. | Tree transition |
| 2012. | Automatic transition | 2211. | At-end transition |
| 2013. | Ready transition | 2212. | Signature transition |
| FIG. 21 | | FIG. 27 | |
| 2100. | Initial state | 2771. | Attribute value of signature |
| 2101. | Idle state | 2771T. | Signature start tag |
| 2102. | Waiting state | 2773. | Attribute size of tree |
| 2104. | Sending state | FIG. 28 | |
| 2105. | Completing state | 2800. | First verification tree |
| 2106. | Signing state | 2801. | Second verification tree |
| 2110. | Workspace transition | 2851. | Second hash tree root node |
| | | 2861. | Padding node |
| | | 2871. | Signature node |

### DETAILED DESCRIPTION

Description—Preferred Embodiment

A preferred embodiment of the present invention is a device for making and verifying combined signatures. The combined digital signature of the present invention is a fairly complex piece of cryptographic specification, algorithms, processes, and devices. The description of a preferred embodiment requires extensive mathematical notation to fully disclose all the relevant details of a preferred embodiment. As such, it is worthwhile to start with an overview of this description.

The description, as a whole, is divided into three parts. The first part reviews the prior art in cryptographic hash trees and illustrates the combined signature tree of the present invention. Since the combined digital signature makes use of an improvement to the Merkle hash tree construction, it is useful to quickly get an idea about where the hash tree fits into the context of the present invention. The illustrative figures are examples for all the later notation.

The second part of the description contains specifications for mathematical relationships between data elements inside a computer system that are necessary for a combined digital signature to function properly. While the concepts are relatively straightforward, the combined signature is nevertheless cryptography and the details are important to a proper and complete disclosure of the present invention.

The third part of the description shows block diagrams of devices for signature making, extraction, and verification. The purpose of the block diagrams is to describe the specific function of each block in relation to the overall device and to specify the electronic signals that pass between them. The specifications of the second part of this description allows a compact description of the devices themselves.

Part 1—Illustrations of a Combined Digital Signature, FIGS. 1-4

The Merkle Hash Tree

It is useful to review to begin with the structure of the Merkle hash tree, disclosed in U.S. Pat. No. 4,309,569, which is herein incorporated by reference. At the bottom is a set of messages (“data items” in the original patent); the number of messages is a power of two. To these messages corresponds a set of leaf nodes, each with a value computed by applying some cryptographic hash function F( ) to a message. These leaf nodes are arranged as the leaves of a binary tree. The value for each parent node is the result of applying the same cryptographic hash function F( ) to the values of the two child nodes. Since such cryptographic hash functions operation on bit strings of arbitrary length, there is no confusion as to the hash function taking one or two arguments. The convention is that multiple arguments are simply concatenated. At each layer the number of parent nodes is half the number of nodes of the layer below. At the top there is but a single node; this node is the root node of the hash tree.

An object of the Merkle hash tree is that individual hash tree signatures can be split off from the entire tree. Each individual hash tree signature is short, even when the tree is large. An individual hash tree signature consists of all the siblings of the nodes on the branch from leaf to root, and an indication of whether each such was a left sibling or a right sibling. Thus instead of sending a whole tree of size n, one can send a set of branch of about size log₂ n. The present invention preserves this advantage of the Merkle hash tree. ps FIG. 1. Exemplary Illustration of a Combined Signature Tree

FIG. 1 shows an illustrative combined signature tree 100 for thirteen messages. The combined signature tree 100 is made up of three layers.

1. Leaf node layer 101 contains one leaf for each of the messages to be signed, numbered in a definite, fixed order.

2. Parent node layer 103 contains the parent nodes of a Merkle-style hash tree. A root node 151 is the root of this hash tree.

3. Public key signature layer 104 contains a public key signature on hash tree root node 151. The public key signature consists of a padding node 161 and a signature node 171. Signature node 171 is also the root of combined signature tree 100.

To each node in a combined signature tree is assigned a value. The value of a leaf node is its corresponding message. Each message is taken to be a short bit string of some fixed length. As is standard cryptographic practice, one may generate such a message from a larger document by application of a cryptographic hash function.

The values in parent node layer 103 are assigned values with a Merkle-style hash tree. The values in public key signature layer 104 are assigned values accordingly to the dictates of a public key signature scheme. Padding node 161 requires an external source of padding bits; its value is the value of hash tree root node 151 plus the padding. Strictly speaking, padding node 161 is the one that receives the signature whose value is in signature node 171. Construction of signature node 171 requires the signer's private key.

A number of nodes have reference numerals attached to them in FIG. 1. Briefly, the individually numbered nodes in FIG. 1 are the relevant nodes for extraction of an individual combined digital signature on message 111. These other nodes are, briefly, leaf nodes 112 and 132, parent nodes 120, 121, 131, 140, and 141, a root node 151, a padding node 161, and a signature node 171. These nodes comprise a sub-tree of combined signature tree 100. This sub-tree is illustrated in FIG. 2 and discussed below.

Component Parts and Validity of an Individual Hash Tree Signature

There is a unique linear tree (that is, one with no side branches) from every node in a tree to the root of that tree; we will call this linear tree the “branch to root”. A Merkle hash tree signature is a set of all siblings of each node on a branch from a certain leaf to root. This set of siblings is called an “authentication path” in the original patent. The siblings are minimally specified by their node values and their positions relative to the branch to root, that is, whether they are left or right siblings.

Validity of an individual hash tree signature is defined as follows. Validity is a relationship between a message, a signature, and a stated value for the root. (The value for the root acts analogously to a public key.) To be valid, the nodes in the signature must first be the siblings of a path to root for some particular leaf node. If so, then these sibling nodes define a signature-derived root value. The signature is valid if the signature-derived root value is the same as the stated value for the root.

FIG. 2. Exemplary Illustration of an Pruned Signature Tree

FIG. 2 shows a pruned signature tree 200 containing only the nodes relevant for an individual combined signature on the message corresponding to leaf node 111. The branch from leaf node 111 to the combined tree root 171 is shown as a signature branch 206. The branch to root of the hash tree consists, in addition to leaf node 111, of parent nodes 121, 131, and 141, root node 151, and padding node 161. Note that the branch to the root of the combined signature tree contains two more nodes than the branch to the root of the hash tree. A sibling set 207 of branch 206 consists of leaf nodes 112 and 132 and parent nodes 120 and 140.

The data for an individual combined signature on message for leaf node 111 consists of the values of sibling hash tree nodes 112, 120, 132 and 140, padding node 161, and signature node 171. These values are all that are necessary to verify a combined signature on message 111 against some public key.

Component Parts of an Individual Combined Signature

The component parts of an individual combined signature are a combination of parts of a hash tree signature and parts of a regular private key signature. A preferred embodiment of an individual combined signature consists of (1) siblings of the branch to the hash tree root on the combined signature tree, both their values and their relative positions to the branch to root, (2) a public key signature at the top of the tree, and (3) a size of the tree.

FIG. 3. Exemplary Illustration of an Individual Combined Signature

FIG. 3 shows an illustrative individual combined signature for the message of leaf node 111. In the preferred embodiment of FIG. 3, the representation convention is XML tags. The labeling convention of FIG. 3 uses reference numerals ending in a final “T” for entire XML tags and reference numerals without such a “T” for elements within a tag. It will be appreciated that the line breaks and white space in the formatting of the illustrative example are not essential to an embodiment of the present invention, but merely a convenience for discretely labeling its parts. Similarly, XML is not the only convention in which to define a signature format; other conventions such as ASN.1 or even ad hoc definitions suffice.

Certain attributes of the tags are hash values of nodes in a tree. These values are shown elided in the drawing, instead of having them clutter the diagram with meaningless (and unverifiable) base-64 values.

An individual combined signature 300T is a signature tag pair, consisting of a signature start tag 371T and a signature end tag 379T, enclosing a sibling tags section 307T. Section 307T consists of left and right sibling tags 312T, 320T, 332T, and 340T. Note that while a combined signature tree is drawn with leaf nodes at the bottom and root at the top, the convention of the combined signature is opposite, with the sibling of the message coming first and thus appearing at the top. Either order would suffice; the illustrated order is more convenient.

Tag 312T is the representation of node 112 as the right sibling of node 111, the leaf node whose individual combined signature this is. Tag 312T has tag name “right”; a value attribute 312 contains the value of node 112. Likewise, tag 320T is the representation of node 120 as the left sibling of node 121, with value in an attribute 320. Similarly, tag 332T (with an attribute 332) represents node 132 and tag 340T (with an attribute 340) represents node 140. Note that the four nodes of sibling set 207 are exactly those of sibling tags section 307T.

Signature start tag 371T contain the value of signature node 171 in an attribute 371. Tag 371T also contains an attribute 372 for hash tree root padding and an attribute 373 for the size of the tree. The complete value of the signature includes not only the attribute 371 value of the signature but also the attribute 372 hash tree root padding.

Validity of an Individual Combined Signature

Validity of an individual combined signature is a relationship between a message, a signature, and a public key. The idea is to reconstruct a pruned signature tree presumably from which an individual combined signature was taken. The last step in reconstruction is to verify that the signature node contains a signature on the padding node.

FIG. 4. Exemplary Illustration of a Verification Tree

FIG. 4 shows a verification tree 400, which illustrates a method of signature verification. Tree 400 is a data structure built from individual combined signature 300T. For the purposes of FIG. 4, we will take individual combined signature 300T as an input rather than an output. That is, tree 400 is defined relative to a signature and a public key, rather than to a message stream and a private key. As a consequence, although tree 400 is similar to pruned signature tree 200, tree 400 is not the same as tree 200, nor is it a sub-tree of combined signature tree 100. In other words, a verification tree is defined from a signature as presented, which may not be the same as a signature as generated.

The node values of tree 400 are defined in two sections. The first section is simply a single node, a signature node 471. The value of signature node 471 is defined as the signature value presented in attribute 371. The second section is the remainder of the tree. A candidate signature edge 401 connects the two parts of a valid verification tree.

The construction of the second section begins with a message node 411, whose value is the value of a message given to verify. The value of a sibling node 412 is the value from attribute 312. The value of a branch node 421 is the properly hashed-together value of node 411 as its left child and node 412 as its right child. Signature tag 312T indicates that node 412 is a right child of its parent.

Working the way up the chain, a sibling node 420 is taken from the next sibling tag 320T, a left sibling. The value of a branch node 431 is the hashed-together value of its left child 420, which is taken from attribute 320, and its right child 421, whose value is defined above.

Similarly, the value of a branch node 441 is the hash of its right child node 431, defined above, and its left child, a sibling node 432, whose position is taken from third sibling tag 332T and its value taken from attribute 332. The value of hash tree root node 451 is the hash of its right child, a sibling node 440 (position from node 340T, value from attribute 340), and its left child 441 (defined above).

Finally, the value of padding node 461 is the concatenation of the pad value from attribute 372 and the value of hash tree root node 451. Candidate signature edge 401 connects padding node 461 and signature node 471. Edge 401 represents that the verification predicate is applied to the values of the two nodes it connects to determine whether there is a valid edge there. Only if the signature predicate on edge 401 verifies can individual combined signature 300T be valid.

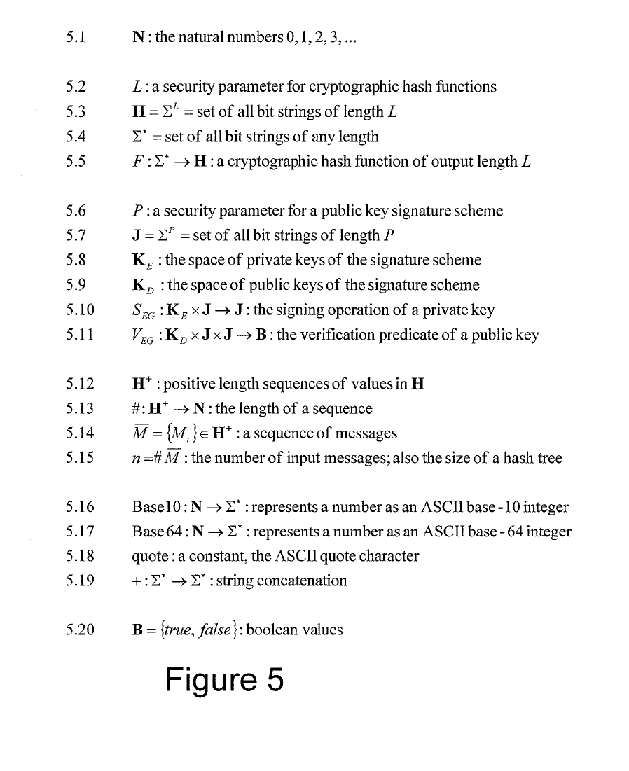

Part 2—Specifications for a Preferred Embodiment, FIGS. 5-14

Part 2 of this description has ten Figures of mathematical notation in three sections. After introducing some notation, the first section contains three figures discussing an improved hash tree technique. The improvement is in the details, which are completely specified. The next three figures show detailed specifications for a combined signature tree. The third section describes individual signatures in the last three figures of this part.

FIG. 5. Definitions and Notation

In order to make the disclosure of the present invention as complete and concrete as possible, FIG. 5 contains notation that will be used to specify data structure and operations throughout this patent.

Equation 5.1 designates the notation for N, the natural numbers.

Equations 5.2 through 5.5 contain notation about a cryptographic hash function. Equation 5.2 designates L as the output length of a cryptographic hash function. Equation 5.3 defines a hash result space H as the bit strings of length L. Equation 5.4 designates the notation for the set of all bits strings, of any length. Equation 5.5 is a type specification for the cryptographic hash function used; it takes arbitrary length inputs and has a fixed length output. (A type specification of a function is a definition of its domain and range.)

The hash function and the security parameter L are specified together as a rule. A preferred embodiment uses SHA-1 as its hash function, where L=160. The hash function F( ) operates on bit strings of arbitrary length and returns results of fixed sizes. An obvious variation of a preferred embodiment is to substitute this hash function.

Equations 5.6 through 5.11 contain notation about a public key signature scheme. Equation 5.6 designates P as input and output lengths of the public key operations. Equation 5.7 defines J as an input and output space. Equation 5.8 designates K_{E} as a space of private keys of a signature scheme. Equation 5.9 designates K_{D} as the corresponding space of public keys. Equation 5.10 is a type specification for a signing operation S_{EG}. The signature operation takes as input a private key and a message value and outputs a signature value. Equation 5.11 is a type specification for a verification predicate V_{EG}. The verification predicate takes as input a public key, a signature value, and a message value; its result is whether the signature is a valid on the message with the given public key.

The cryptographic signing operation S_{EG} and verification predicate V_{EG} are a matched pair for a given public key signature system. A preferred embodiment uses the ElGamal public key signature system. As of the writing of this disclosure, a preferred embodiment uses M=1024. The parameter M may be increased over time, as necessary, for the security of the system. In the sequel, we will suppose that public key d is derived from private key e according to the key generation process associated with the public key signature system.

Cryptographic signing operation S_{EG} may require a source of random bits in order to make a signature. The ElGamal signature, amongst others, has this property. As such, the operation S_{EG} is non-deterministic. The verification function V_{EG}, however, verifies any output of S_{EG} as a valid signature. In the foregoing, a signature operation will be presumed to supply its own source of random bits, which will not be separately illustrated. An obvious variation of a preferred embodiment is to substitute the cryptographic signature scheme. Not all signature schemes require random bits. The convention that a signature operation will supply its own source of random bits if needed allows a substitution of signature scheme to be more readily grasped.

Equations 5.12 through 5.15 contain notation about input messages. Equation 5.12 designates H⁺ as the set of sequences of values in H. Sequences in H⁺ always have at least one element in the sequence. Equation 5.13 is a designation of #, the length operator. Equation 5.14 designates the notation M as a particular sequence of messages. We will use \overline{M} to denote the input sequence for the construction of a hash tree or a combined signature tree. Equation 5.15 designates n to denote the number of leaves in a hash tree or combined signature tree under consideration.

Equation 5.16 designates notation for a base-10 conversion function. Equation 5.17 designates notation for a base-64 conversion function. Equation 5.18 is a name for the ASCII double-quote character. All of these items are conventional practice.

Equation 5.19 designates the use of the + operator as representing string concatenation as an operator between bit strings, in addition to representing regular addition.

Equation 5.20 designates B as the set of true/false values.

Ordered Trees

A preferred embodiment of a combined digital signature uses a family of hash trees that augment the Merkle hash tree construction. In the Merkle hash tree patent, formulas were shown only for the class of complete binary trees (size a power of two), but that patent mentions at the end that other kinds of tree construction would also work. The class of trees that the Merkle construction works on are the class of ordered trees.

We must first define an ordered tree. A tree is a connected, directed acyclic graph. It has, therefore, a unique root node that every path leads to. An ordered tree is a tree with an ordering on the leaf nodes and a special planarity property: if the leaf nodes are arranged on the x-axis of the plane, then the graph has a non-crossing embedding in the upper half-plane. (This is a fancy way of stating that you can lay out an ordered tree in the conventional way, with its leaves in increasing order at the bottom of a diagram.) In general, any tree has an ordering that supports the Merkle hash tree construction. The principle for constructing a Merkle hash tree on an arbitrary tree is simple: the value of a parent node is equal the result of a cryptographic hash function applied to the concatenation of its children. If the order of concatenation was not fixed in advance, computing such a concatenation determines an order for the tree. In the following, we will consider any Merkle hash tree to have operated on an ordered tree, since the computation of such a tree generates an ordering if there was not one before.

One notable property of ordered trees is useful for describing a preferred embodiment of a combined signature tree. Every parent in any directed acyclic graph has a collection of leaf nodes as its eventual descendants. In an ordered tree, this collection of leaves is a contiguous sequence of nodes. By convention, we number the leaf nodes with nonnegative indices beginning at zero. Thus the position of every node in an ordered tree has a unique representation as the first and last indices of its set of contiguous leaf progeny. This is a consequence of the non-crossing embedding that defines an ordered tree. In other words, each node in the ordered tree has a position that is very easy to encode; it's simply a pair of numbers. Trees that are not ordered trees still have ways of specifying the position of its nodes, although they are not as simple as for ordered trees. A preferred embodiment of a combined digital signature uses this property of ordered trees to specify its node positions. Indeed, the tree illustrated in FIG. 1 is an ordered tree and the nodes are labeled with this convention.

The position pair convention for ordered trees has two notable invariants. In a hash tree of n leaves, the position of the root is always <0,n−1>, no matter what the tree shape, because the root must always be an interval with n elements, beginning with 0. The position of a leaf is always of the form <i,i>. Because the leaf is a sub-tree of a single element, it must be represented by an interval of length 1.

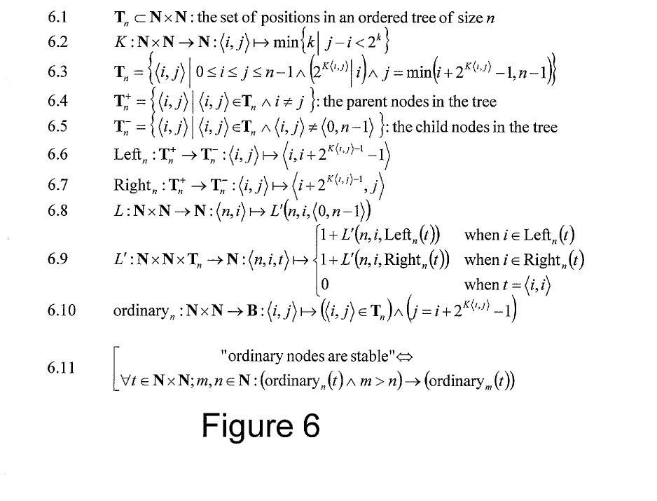

FIG. 6. Specification and Properties of Left-Balanced Binary Trees

FIG. 6 defines a particular class of ordered trees that called left-balanced binary trees, or LBB-trees for short. There is a single LBB-tree shape for every size of tree. Each such tree is an ordered tree, so we can specify all the nodes of the tree as a set of ordered pairs Tₙ. Because any ordered tree has the property that siblings form contiguous intervals, specifying all nodes in a tree also defines every parent and child relationship within the tree. The definition of Tₙ, thus also defines the structure of tree.

Equation 6.1 is a type specification for Tₙ as a set of ordered pairs. Each member of Tₙ corresponds to a node in the tree.

Equation 6.2 is a definition of K( ), a function gives the number of bits that a pair of numbers differ at the end after a shared initial substring (if i<j). When the context is clear, we will say the k-value of a node <i,j> is the value K<i,j>.

Equation 6.3 is a definition for Tₙ. The first predicate states that the indices of a node in the tree must denote a sub-interval of the total interval [0,n−1]. The second predicate says that 2 to the k-value divides the first index, that is, the first index must end in k zero-bits. The third predicate states that the second index must end in k one-bits or be equal to the maximum index n−1.

While this is not the place for exhaustive proofs, an exposition of a few of the properties of these LBB-trees is in order. An LBB-tree is a binary tree, with each non-leaf node having exactly two children. An LBB-tree is ordered, so we can call these children left and right without confusion. (We use the zero-on-the-left, increasing-to-the-right convention illustrated in FIG. 1.)

The leaves, with node indices equal to each other, have k-values of zero. Parent nodes have k-values greater than their children. The root node has k-value equal to the bit length of n−1. The longest branch to root has K<0,n−1>+1 nodes, including leaf and root nodes. An LBB-tree has the minimum tree depth possible for any binary ordered tree of its size, so the tree is “balanced” in the sense that there are no long paths to root.

The tree is left-balanced because longer paths to root are all to the left. Indeed, an LBB-tree has a monotonicity property; the lengths of branches to root never increase going from left to right. Precisely, if a<b, then the branch from leaf node <a,a> to root is at least as long as the branch from leaf node <b,b> to root. The length of the branch from leaf to root achieves is maximum value at the first leaf node <0,0>.

Equation 6.4 defines a subset of the tree Tₙ⁺, which is the set of nodes with children; this set excludes the leaf nodes. Equation 6.5 defines a subset Tₙ⁻, which is the set of nodes with parents; this set excludes the root node.

Equation 6.6 is a type specification and definition of navigation function Leftₙ( ) Equation 6.7 is a type specification and definition of navigation function Rightₙ( ). Note the interval-splitting property of the children. First indices of a parent and a left child agree; second indices of a parent and a right child agree. A left child interval is contiguous with a right child interval; together they comprise all the parent interval.

Equation 6.8 is a type specification and definition of a leaf branch length function L( ). The parameters to L( ) are a tree size and a leaf index. The value of L( )is equal to the length of the branch from leaf to root, counting edges (in other words, one less than the value of counting nodes). L( )is defined as a particular value of L′( ) with the same initial parameters, explained below.

Equation 6.9 is a type specification and definition of a general leaf path length function L′( ). L′( ) takes the same parameters as L( ), but adds an additional node parameter. L′( ) returns the distance from a leaf node (the second parameter) to a branch node (the third parameter) along the branch to root. If the branch node is not on this branch, the function is not defined. It is straightforward to define L′( ) recursively, since one can simply add one for every recursion taken going down the branch. Now we can explain the definition of L( ). The value L( )is a special value of L′( ) for the length of the path to the root node, which is a part of every branch.

Equation 6.10 is a type specification and definition of a predicate ordinaryₙ( ). An ordinary node, roughly speaking, is a node that doesn't have anything to do with the exceptional behavior found at the rightmost branch from leaf node <n−1,n−1> to root node <0,n−1>. Some nodes on rightmost branches are ordinary. In particular, when n is a power of two, all the nodes on the branch are ordinary. Thus an LBB-tree whose size is a power of two is composed entirely of ordinary nodes.

Equation 6.11 is a formal definition of a stability property of ordinary nodes. Every ordinary node in a tree is also an ordinary node in every larger tree. This property boosts performance of signature-making by allowing incremental computation. Creating an ordinary node can be done as soon as possible, since it will not change position thereafter. The non-ordinary nodes are at most log₂ n in number, so it is possible to construct most of the final tree as messages arrive, without knowing the eventual size of the tree in advance. One of the reasons to select LBB-tress, as opposed to other trees, is exactly for this stability property.

Tree Extensions

At this point it is worthwhile to explain in greater detail the object of modifying the Merkle hash tree. The original Merkle hash tree exhibits a security hazard in certain modes of use. Suppose that a signature-maker is to sign messages presented by others (say, a signature server making signatures for a number of web servers). Further suppose that a presenter computes a hash tree in advance and transmits the concatenation of the two children of its root to the maker. The maker will happily hash this concatenation and incorporate it into the maker's own tree. The presenter can extend the signature on the message with nodes from their own private tree. The presenter has converted a single signature into more than one signature, whereas the maker would only suppose a single signature to have been made. This attack is called a tree extension. It breaks the principle that a maker should always know exactly what they have signed.

The tree extension attack is possible with the Merkle hash tree for two reasons. First, the structure of the signature does not indicate anything about the tree structure from which the signature was extracted. Second, the hash function F( ) is known widely, and an opponent is able to construct a tree extension in advance. One can address these problems either by adding information about the tree structure or by manipulating the hash functions, or both. There are several ways to address these issues. For example, one can add information to the signature format about the overall tree structure. This is the technique demonstrated in a preferred embodiment. Other techniques are described below as embodiments and minor variations.

Note, however, that none of these techniques to prevent tree extensions are necessary for proper functioning of the combined signature in general. Only in certain situations do tree extensions present an actual security risk. In other situations, protection against tree extension in unnecessary, but the advantages of the present invention unrelated to tree extension still remain useful.

Position-Dependent Hash Trees

A preferred embodiment of the present invention augments the basic construction of a hash tree by using a position-dependent hash function. In the Merkle construction, the hash function is the same for every position in the ordered tree. A position-dependent hash function takes as arguments, in addition to the values of the child nodes, the position of the node which is being computed. With position-dependent hash functions, one places position information into the hash tree, thus enabling detection of tree extension attacks.

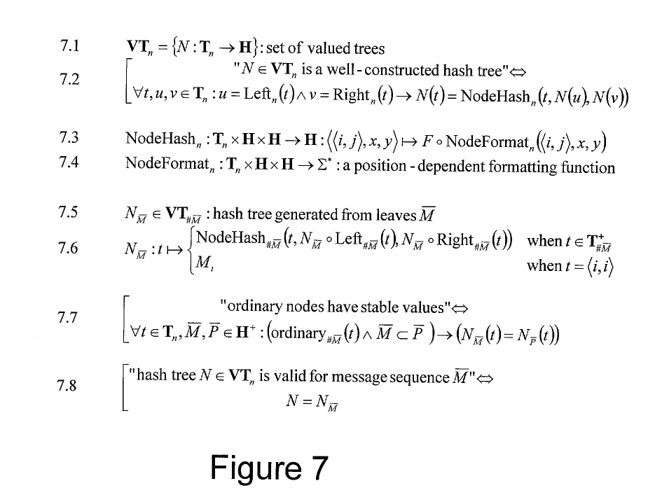

FIG. 7. Specification of Node Values for a Hash Tree

FIG. 7 illustrates a specification for a position-dependent hash tree of size n as used in a preferred embodiment. A hash tree is a combination of a tree structure and a value for each node in the tree. While FIG. 6 specifies the structure of LBB-trees, it does not specify the values associated with any of the nodes. FIG. 6 shows only the structure of an LBB-tree, that is, the names of the nodes and the connectivity between them. Notably absent from FIG. 6 are the messages upon which a signature might be made. FIG. 7 incorporates a message sequence as values assigned to the leaves of a hash tree.

Equation 7.1 is a definition of a set of “valued trees” VTₙ. A valued tree is a “value function” from Tₙ into a value range, in this case H. A hash tree is a particular kind of valued tree whose values are consistent with the hash tree construction principle.

Equation 7.2 is a definition of a well-constructed hash tree N. A hash tree is well-constructed if the value of every parent node is the hash of its two child nodes. This predicate allows a description the structure of a hash tree constructor to be separate from a description of its operation. The structure of a device states that certain signals have designated properties; an algorithm states how to compute those signals.

Equation 7.3 is a type specification and definition for NodeHashₙ( ), a hash function for a hash tree. NodeHashₙ( ) takes as inputs a tree position, the value of a left child, and the value of a right child; its result is a hash value. NodeHashₙ( ) is thus a position-dependent hash function, because its result depends upon position. The value of NodeHashₙ( ) is the result of a standard hash function F( ) and “formatting function” NodeFormatₙ( ), defined below.

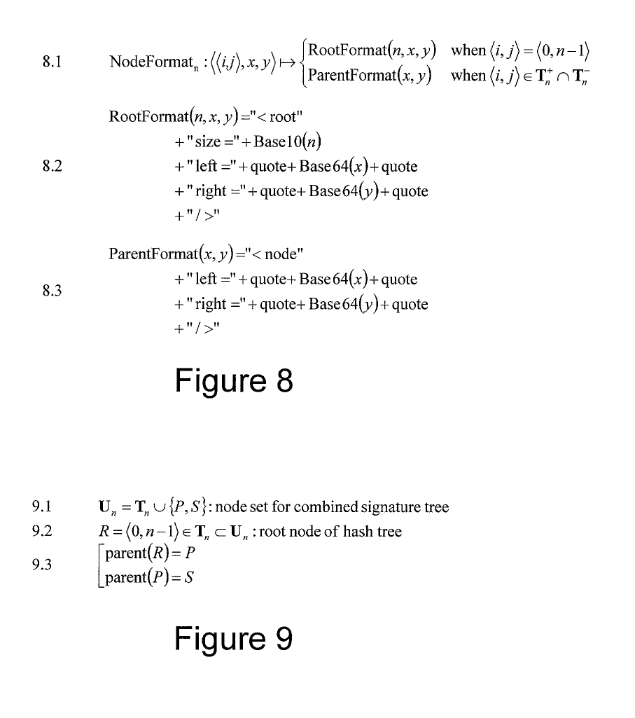

Equation 7.4 is a type specification of a “formatting function” NodeFormatₙ( ). The formatting function takes the same inputs as NodeHashₙ( ); it results in a bit string suitable for hashing. A formatting function is a functional specification for an algorithm used to encode node positions and child values before hashing. A preferred embodiment uses a definition of NodeHashₙ( ) in FIG. 8, discussed below.

Equation 7.5 is a type specification for valued tree N_{\overline{M}}, a value function from the nodes of tree Tₙ to value space H. This function depends upon an input sequence of messages \overline{M}. To each possible sequence of messages there is a defined value function, which is a way of saying that every sequence of messages generates a hash tree. This separation of structure and value allows a more clear exposition of possible variations of the present invention.

Equation 7.6 defines value function N_{\overline{M}}( ) recursively down from the root to the leaves. The value of each parent node depends upon its own position and the values of its two children. The recursion bottoms out at the leaves. The value of a leaf node is simply the value of the corresponding message in the message sequence that defines the value function. The reader can check that N_{\overline{M}} is a well-constructed hash tree.

Equation 7.7 is a formal definition of a stability property for the value function on LBB-trees. The property says that if a node is ordinary in a tree constructed from some message sequence, that the value of the node does not change in a larger tree constructed from an extension of that sequence. In other words, the stability property for the existence of nodes in an LBB-tree also carries over into the value function. Therefore, not only is it possible to construct a tree incrementally, it is also possible to compute the values of its nodes incrementally.

Equation 7.8 defines a predicate that characterizes a valid hash tree for a message sequence \overline{M}. A given hash tree is valid for a message sequence if it is equal to the hash tree generated from that message sequence. This definition illustrates the principle (which will be used elsewhere) that definition of the value of a tree (hash tree or combined signature tree) is not the same as a definition of its validity. The distinction between N and N_{\overline{M}} in the definition is that N is given by the values of all its nodes and N_{\overline{M}}, on the other hand, is given by construction from a message sequence. In other words, a hash tree constructor operates correctly when its output (a hash tree given by its set of values) is equal to the definition of a hash tree generated from its input.

Because the value of a node depends upon its position, the hash tree of a combined signature is different than that of the Merkle hash tree. The dependence of value on position is a central technique for protection against tree extension. Position-dependent hash trees can prevent tree extensions, but the Merkle hash tree cannot. Use of a formatting function simplifies the specification and security analysis of position-dependent hash functions, by allowing well-known cryptographic hash functions to be used as primitives. It will be apparent, though, that formatting functions are not the only way of obtaining position-dependent hash functions.

A preferred embodiment uses the LBB-trees of FIG. 6, but it is apparent that the definition of the value function N_{\overline{M}} is also valid for any class of binary trees with a defined node-set Tₙ and navigation functions Leftₙ( ) and Rightₙ( ). Likewise, a preferred embodiment uses the formatting function definitions of FIG. 8, yet the method for specifying node values is also valid for other formatting functions.

FIG. 8. Specification of Position-Dependent Formatting Functions

FIG. 8 shows a specification for a position-dependent hash function, NodeFormatₙ( ), used in a preferred embodiment. This hash function uses XML formatting conventions to define root and parent data formats. Each format result is a single XML tag containing a node position and the values of its two children. It will be appreciated that XML is not necessary here; other formatting conventions would work just as well.

Equation 8.1 is a definition of NodeFormatₙ( ). This formatting function uses two different formats to distinguish between the root node and non-root parent nodes. This is how this formatting function uses its position dependence. It will be appreciated that while the use of position dependence is subtle, the definition of NodeFormatₙ( ) would not be possible outside of the context of position-dependent hash functions.

Equations 8.2-3 both use ASCII string constants; in both equations the operator+represents string concatenation. Equation 8.5 is a definition of RootFormat( ), a formatting function for root nodes. The XML tag name identifies it as a root, and the result contains a representation of the size of the tree. Equation 8.6 is a definition of ParentFormat( ), a formatting function for non-root parent nodes. Each formatting functions takes as parameters the values of a node's two children.

Prevention Against Tree Extensions

The particular formatting functions of a preferred embodiment protect against tree extension by validating the signature path against valid LBB-tree shapes. The signature information contains a set of sibling nodes, specified as right or left siblings. The signature also contains the size of the tree. These sibling designations uniquely identify a path to root and thereby also identify the message number. This identification is unique because the tree is known to be an LBB-tree of the given size. It is straightforward to tell whether a designated path is part of the given LBB-tree. If the path is not a valid path in the LBB-tree, then the signature is not valid.

It will be appreciated that any class of ordered trees supports this approach against tree extension. So long as there is a unique member of such a class for any given size of tree, it is possible to include in the definition of signature validity a test between the branch-as-computed and a branch-as-is-possible. If the computed branch is impossible, the signature is invalid.

FIG. 9. Specification of a Combined Signature Tree Structure

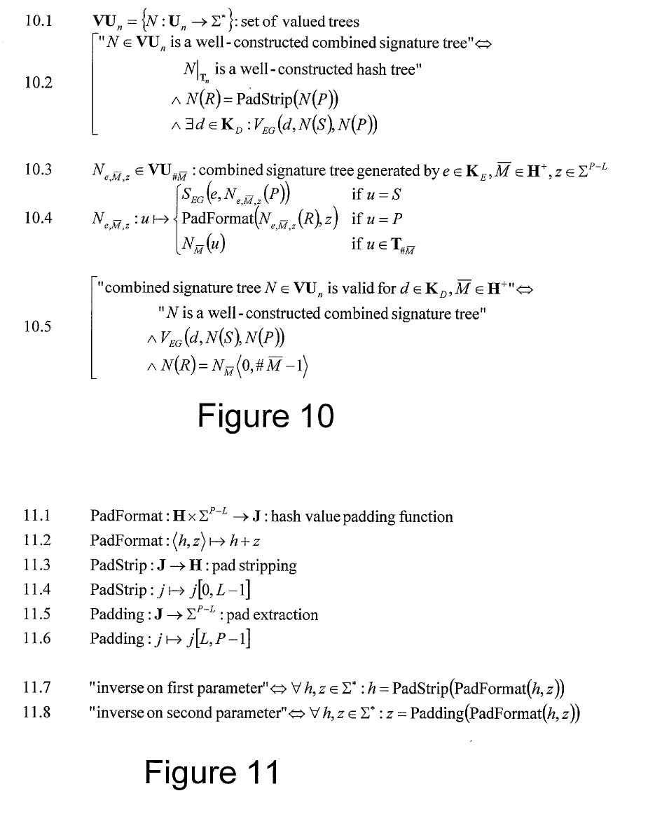

FIG. 9 shows a specification for the nodes and structure of a combined signature tree. Analogously to the description of a hash tree, the structure definitions are in one figure (FIG. 9) and the value definitions are in another (FIG. 10 below).

Equation 9.1 is a definition for a node set Uₙ of nodes in the (unvalued) base tree of a combined signature tree of size n. The node set Uₙ is the node set of an LBB-tree of size n together with a padding node P and a signature node S.

Equation 9.2 is a designation of R as the hash tree root node of the base tree of a combined signature tree.

Equation 9.3 is the remainder of the structure definition not induced from Tₙ. The parent of the root node the hash is the padding node. The parent of the padding node is the signature node. The signature node has no parent.

FIG. 10. Specification of Node Values of a Combined Signature Tree

FIG. 10 shows a definition of a class of combined signature trees, a definition of a particular combined signature tree that is generated from parameters, and a definition of signature tree validity for a message sequence and a public key.

Equation 10.1 is a definition of a set of valued trees VUₙ, a set of value functions from base trees of a combined signature tree into a value range, in this case Σ*. The set VUₙ of valued trees is a type specification for a combined signature tree. A combined signature tree is valued tree in VUₙ with certain properties.

Equation 10.2 is a definition of a well-constructed combined signature tree. First, a combined signature tree must contain a well-constructed hash tree. Since N is a value function on Uₙ, then the restriction of N to Tₙ is a potential hash tree. Second, the value of the padding node must be equal to some padding concatenated with the value of the root. Third, there must be some public key such that the signature node is a signature on the padding node. Note that this definition of a combined signature tree does not mention a particular message sequence nor public key. This is a definition of the class of all combined signature trees, not a definition of whether a signature tree is valid for some particular message sequence and public key.

Equation 10.3 is a type specification for a combined signature tree N_{e,\overline{M},z}. This combined signature tree depends on three subscripted values. e is a private key for making a cryptographic signature, \overline{M} is a sequence of input messages, and z is a padding value.

Equation 10.4 is a definition for combined signature tree N_{e,\overline{M},z}. Similarly as with the hash tree N_{\overline{M}}, this value function is defined recursively down from the top of the tree. The value of the signature node is the result of a signature operation of the public key scheme applied with the private key and the value of the padding node. The value of the padding node is the result of a formatting function on padding z of the value function and the value of the hash tree root node. The value of the hash tree nodes, including that of its root, is taken from hash tree N_{\overline{M}}.

Equation 10.5 is a definition of validity of a combined signature tree N for a public key d and a message sequence \overline{M}. A combined signature tree is valid for a particular message sequence and public key if three conditions hold. First, N must be a well-constructed combined signature tree. Second, the signature must verify not just with any public key, but with d. Third, the value of the root node must be equal to that generated by the given message sequence \overline{M}.

The definition of combined signature tree validity illustrate an important principle in the specification of a preferred embodiment. The definition of a function or predicate should not be taken immediately as an indicator that a preferred embodiment will contain an algorithm that computes that function. While some of the functions have such corresponding value-computing algorithms in a preferred embodiment, others do not. The combined signature tree validity predicate defines the correctness of the result of an algorithm, not how one might compute such a result.

With this point in mind, the validity predicate of Equation 10.5 is used in defining correct operation of a device that makes signatures. Note that although a private key is required to construct a valid combined signature tree, no private key appears in the definition of validity-only a public key. On the other hand, no public key is used in the construction of a combined signature tree.

FIG. 11. Specification of Padding and Stripping Functions

FIG. 11 shows type specifications and definitions for padding and stripping functions used in FIG. 10 and elsewhere.

Equation 11.1 is a type specification for a padding function PadFormat( ), which is used to pad out the value of the hash tree root to the size required for a public key signature operation. Since a hash value is shorter than an input to a signature operation, there is a bit string input to make up the difference. This bit string is P−L bits long, the difference in lengths.

Equation 11.2 is a definition for PadFormat( ). The inputs are bit strings. The operator+is string concatenation.

Equation 11.3 is a type specification for PadStrip( ), which ignores the irrelevant bits from a result of a public key signature verification. This function is used to define combined tree signature validity .

Equation 11.4 is a definition for PadStrip( ). The input is a bit string. The square bracket notation for the result is that of array subsequence. The result is the extraction of bits 0 through L−1, inclusive, that is, the first L bits.

Equation 11.5 is a type specification for Padding( ), which extracts the padding bits from a padding node value. Equation 11.6 is a definition of Padding( ), which extracts the last P−L bits from its input.

Equation 11.7 is a characterization of the relationship between PadFormat( ) and PadStrip( ). It should be apparent that PadStrip( ) is the inverse of the restriction of PadFormat( ) to its first parameter (a hash value). Similarly, Equation 11.8 is a characterization of the relationship between PadFormat( ) and Padding( ).

These two inverse relationships characterize a class of variations to a preferred embodiment. A set of padding functions that meets the type specifications and satisfies the inversion relationships can plug into the rest of the formulas without modification. Other padding techniques, however, are possible with more extensive modification to other parts of the specification. These variations would add little clarity to the exposition and are not illustrated.

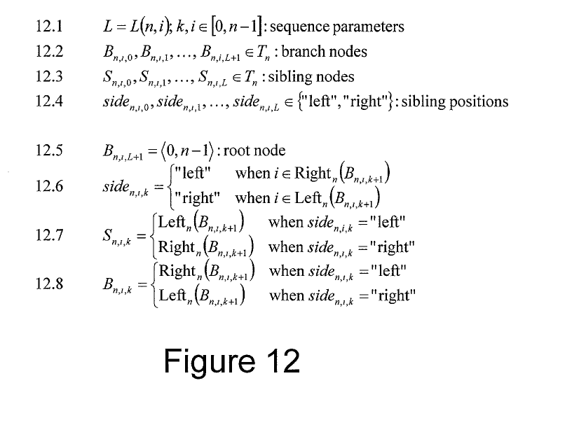

FIG. 12. Specification of a Sibling Sequence for an Individual Signature

FIG. 12 defines a branch to root and a sibling sequence for a message in a hash tree of size n. These definitions are preparatory to defining an extracted individual combined signature.

Equation 12.1 designates L as the length of a sibling sequence of leaf node <i,i>. Equation 12.1 also designates k and i as sequence parameters. k is a sequence index; i is an index for a message whose extracted signature is being defined.

Equation 12.2 is a type specification for branch nodes. Equation 12.3 is a type specification for sibling nodes. Equation 12.4 is a type specification for sibling position indicators. Note that the branch nodes are defined through L+1, but the sibling nodes and positions are only defined through L. This is because the root has no sibling.

Equation 12.5 is a definition of B_{n,t,L+1} as the root node of the hash tree. The pruned subtree is defined from the root downward.

Equation 12.6 defines side_{n,t,k} as “left” if the index t is in the right child of branch node above and as “right” otherwise. Left and right here are position of the sibling with respect to the branch. This is the convention as is used in FIG. 2. Equation 12.7 defines the sibling node S_{n,t,k} in the obvious way: as the left child of the parent if on the left side, and as the right child if on the right. Equation 12.8 defines the branch node B_{n,t,k} as the other child node. Note that the index i is always in the branch, not in the sibling.

As a subtree, the values of the nodes of this subtree are induced by their inclusion in a larger hash tree. Hence the definitions in FIG. 12 of a subtree and a sibling sequence are structural. Values for these nodes do not change during pruning, so no separate definition of a node value function is required.

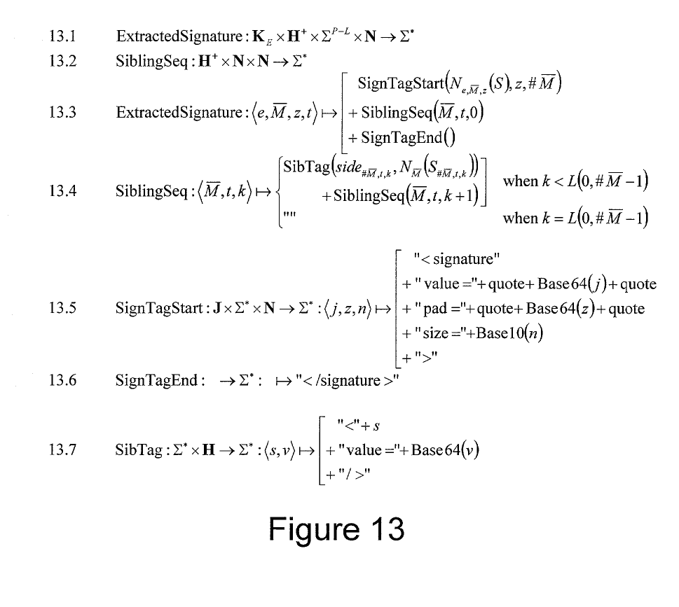

FIG. 13. Representation of an Individual Combined Signature

FIG. 13 shows representation functions for an individual combined signature. The formatting convention here is XML.

Equation 13.1 is a type specification for ExtractedSignature( ), a function which defines an extracted, individual combined signature on a single message out of a sequence. ExtractedSignature( ) takes all the arguments to form a combined tree signature and adds an index for the specific message to extract a signature for.

Equation 13.2 is a type specification for SiblingSeq( ), a function which represents a sibling sequence within an extracted, individual combined signature. The first parameter is a sibling sequence. The second parameter is a leaf node index. The third parameter is a starting index in the branch.

Equation 13.3 is a definition of ExtractedSignature( ). The result of ExtractedSignature( ) is a sibling sequence enclosed with a signature tag pair. The parameters to SignTagStart( ) are a signature value, padding, and a tree size, each of which become attribute values. The parameters to SiblingSeq( ) are a message sequence, a particular message index, and zero. The third parameter of zero means that the SiblingSeq( ) result incorporates the entire sibling sequence.

Equation 13.4 is a definition of SiblingSeq( ). SiblingSeq( ) is defined recursively, as the concatenation of a designated sibling tag and the sibling sequence that starts one index higher. The parameters to SibTag( ) are (1) the position indicator and (2) the value, both of the siblings at height k along the branch from leaf t in the tree generated by message sequence \overline{M}. When the height parameter k is equal to the length of the branch, the result is the empty string; all nodes have been formatted; the recursion stops and the sequence ends.

Equation 13.5 is a definition of SignTagStart( ), which presents a signature value, a pad, and a tree size in a straightforward XML start tag structure.

Equation 13.6 is a definition of SignTagEnd( ), which is a constant function with no domain. The result of the function is an XML end tag.

Equation 13.7 is a definition of SibTag( ), which presents the position indicator and value of a sibling. The tag name is the same as the position indicator, either “left” or “right”.

Parsing and Reconstruction of an Individual Combined Signature

The results of ExtractedSignature( ) are self-contained signatures that only require a public key and an original message for verification. Individual signatures are separate from each other and can be transmitted to another party individually. Therefore, validity of an individual signature is defined in reference to the data contained in an individual signature, not in the message sequence that generated a combined signature tree. This is directly analogous to the nodes of the verification tree of FIG. 4 having different reference numerals than those of FIG. 2.

The validity of an individual combined signature depends upon a certain mathematical consistency between its node values, its position indicators, and its tree size. The presentation of a signature is in textual form, however. Strictly speaking, the validity of an individual signature should be specified as relationships about the textual content of the presentation. One would define a formal language for well-formed extracted signatures. The specification of validity would include the predicate that the signature was well-formed and that data structures were extracted faithfully from it.

Parsing technology, though, is well-understood and a full mathematical treatment would add no clarity to a description of a preferred embodiment. Therefore, we will compact the specification for validity concerning parsing and interpretation into data structures into the simple natural-language predicate “the signature is well-formed.”

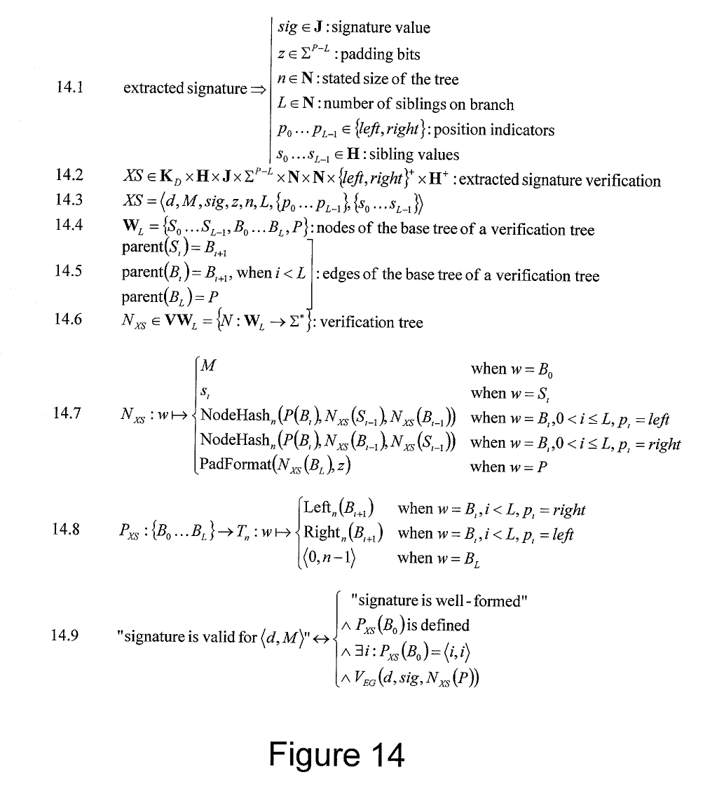

FIG. 14. Validity of an Extracted Individual Combined Signature

FIG. 14 is a specification for validity of an extracted signature.

Equation 14.1 designates the data extracted from a well-formed signature. We will define signature validity with these values, together with the assumption that the signature is well-formed. sig is the signature value, taken from attribute “value” of tag “signature”. z is padding bits, and n is the size of the tree, both values taken from signature start tag attributes. L is the number of siblings, taken by counting the number of sibling tags. A sequence of position indicators are taken from the tag names of the sibling sequence. A sequence of sibling values is taken from the attribute “value” of the sibling tags. The indices on the sibling sequences are taken from first to last appearance, starting with zero.

Equation 14.2 is a type specification of XS as a extracted signature verification parameter. Equation 14.3 is a definition of the individual values of XS. An XS vector defines a node value function with which to define validity of an extracted signature. XS consists of a public key, a message value, and all the extracted signature values. XS is a shorthand used in the definition of the node value functions for the verification trees.

Equation 14.4 is a specification for the nodes of W_{L}, the base tree of a verification tree of branch length L. (Note: This is one less that the L used in FIG. 12.) Equation 14.5 is a specification for the edges of W_{L}, written as values of a parent navigation function. The nodes in this tree correspond to a pruned hash tree of a combined signature tree. Note that there is one more B node than S node. B_{L} corresponds to the root of a hash tree and has no sibling. The P node is for a recomputed padding node. The left-right ordering of this tree is according to the position indicators in the extracted signature (notation not illustrated).

Equation 14.6 is a type specification for a verification tree N_{XS}, which as usual, is a value function on an underlying base tree.

Equation 14.7 is a definition of N_{XS}. The value of the bottom branch node B₀ is the value of the message against which validity is being defined. The values of the sibling nodes are the values taken from the individual signature. The values of other branch nodes are computed with position-dependent hash function NodeHashₙ( ), defined in Equation 7.3; the position parameter is the value of P_{XS}( ) (see below) applied to the branch node. The values of the children are computed recursively; recursion ends at either a sibling node or at the leaf/message node. Finally, the value of the padding node is the prospective root value with the padding.

Equation 14.8 is a type specification and a definition for a function P_{XS}( ), which yields tree positions in Tₙ for prospective branch nodes of a verification tree. The top node B_{L} is assumed to be the root. Other nodes are left or right children of their parents, opposite of the position indicator, which is the position of the sibling. It is important to note that P_{XS}( ) is only defined completely for valid position sequences. This definition property is a mechanism for ascertaining branch validity in order to protect against tree extensions. If the value is defined, then the branch is not too long. If the value is a leaf node, it is also not too short, and thus valid. These two parts of branch integrity appear below in a definition for validity of extracted signatures.

Equation 14.9 is a definition of validity for individual combined signature. An individual combined signature is valid if and only if it (1) is well-formed, (2) if the tree position of the bottom branch node is defined, (3) if the bottom branch node is a leaf node, and (4) the signature verifies against the padding node with the public key. This definition of signature validity is used to define the proper operation of a device that verifies an individual combined signature.

Note that verification requires that the padding be present in the extracted signature so that a signature verification predicate can operate on (presumably) the same message used to make the signature in the first place. A minor variant is that if the padding is deterministic, it could be omitted from the signature format and recalculated during verification. A somewhat more extensive variation uses public key signature schemes with message recovery, described below as a variant embodiment.

Part 3—Block Diagrams of Devices

FIG. 15. Diagram for a Device that Makes Combined Digital Signatures

FIG. 15 shows a block diagram of a device that makes individual combined digital signatures. This device has both synchronous (that is, subroutine-like) and asynchronous (that is, server-like) modes of operation.

Input to the device begins with a message sequence source 1500. Source 1500 receives messages from external sender(s), who submit messages for signing. Source 1500 contains an internal queue that can serialize external messages, that is, put them in a definite order. The output of source 1500 is a sequence of values in H and is the input to a hash tree constructor 1503. The output of constructor 1503 is a hash tree signal 1510.

Signal 1510 is a well-constructed hash tree; that is, it obeys the predicate about hash tree validity of Equation 7.2. Furthermore, signal 1510 is a valid hash tree for the message sequence of source 1500, obeying the predicate of Equation 7.8. Hash tree signal 1510 is one of three inputs to a root node signer 1504.

A private key storage 1501 provides a private key input to signer 1504. A padding source 1502 provide a third input to signer 1504. In a preferred embodiment, source 1502 is a random number generator.

The output of signer 1504 is a combined signature tree signal 1511. Signal 1511 obeys the validity predicate of Equation 10.5 for the input message sequence, the public key corresponding to the private key in storage 1501, and the top node signature value of tree signal 1511.

Signal 1511 is a first input into a signature extractor 1506. A second input to extractor 1506 is a message selection 1505. The output of selection 1505 is a signal indicating a message index into the message sequence from source 1500. The output of extractor 1506 is a signature output 1507. Output 1507 obeys the validity predicate in Equation 14.9 for the input message corresponding to selection 1505 and the public key corresponding to the private key in storage 1501.

Absent from the device is a master controller for scheduling. In the design of FIG. 15, all coordination is done locally, so there is no need for a master clock or any similar control mechanism. While a signature making device could certainly be created with such a controller, it is not necessary for the proper functioning of the device.

FIG. 16. Diagram for an Individual Combined Signature Verification Device

FIG. 16 shows a block. diagram of a device that verifies combined digital signatures.

Input to the device is a signature source 1600 and a message source 1601. Signature source 1600 is an input to a parser 1602, which converts the transmissible form of source 1600 into an internal representation. Parser 1602 also ensures that the signature source 1600 is well-formed.

The output of parser 1602 and message source 1601 are inputs to branch constructor 1604. Constructor 1604 builds a verification hash tree and outputs the value of its root a public key verifier 1606. Constructor 1604 also checks to ensure that the branch so constructed is valid for the LBB-tree of size stated in signature source 1600.

The output of parser 1602 also contains a signature value that is an input to verifier 1606. (This signature value may include padding.) A third input to verifier 1606 comes from a public key storage 1603. Verifier 1606 computes a public key verification predicate on the signature value output of parser 1602, the root value output of constructor 1604, and the public key from storage 1603. If any input is “invalid”, as would be the case if the signature were malformed or the branch was illegal, then the output of verifier 1606 is also “invalid”. Otherwise, a verification output 1607 is either “valid” or “invalid”, depending whether the key verification procedure succeeded or failed.

Operation—Preferred Embodiment

FIG. 17. Flowchart for Making an Individual Combined Signature

FIG. 17 shows a flowchart for computing an individual combined signature. The flowchart of FIG. 17 is a description of a synchronous mode of operation, in which an input of a message sequence and a private key generate a combined signature tree from which to extract an individual signature, after which the device stops until restarted. Operation begins with an LBB-tree construction procedure 1700, which builds an LBB-tree of size equal to the length of a message sequence 1701. The constructor computes a tree according to the specification of an LBB-tree in FIG. 6. A node set is computed in accordance with Equation 6.3, the definition of Tₙ. Parent and child relationships follow according to the properties of an ordered tree.

After the construction of an LBB-tree, a leaf valuation procedure 1702 computes values of the leaf nodes according to Equation 7.6, taking message sequence 1701 as leaf values. Following this, a tree valuation procedure 1704 computes the values of each node of the LBB-tree according to the specification of FIG. 7, using the position-dependent formatting functions of FIG. 8. The result of procedure 1704 is a valid position-dependent hash tree computed from sequence 1701.

A padding procedure 1706 then creates a padding node according to FIG. 9 and computes a value for it by adding padding bits 1707 to the root of the hash tree resulting from procedure 1704. This computation is in accordance with Equation 10.4 and 11.1.

A signature operation 1708 then creates a signature node according to FIG. 9 and computes a value for it by applying a signature operation corresponding to a private key 1709. This computation is accordance with Equation 10.4. The resulting tree is a valid combined signature tree according to the characterization of validity of Equation 10.5.

An extraction procedure 1710 then computes a sibling sequence corresponding to particular message from sequence 1701 chosen according to the index of a message selection 1711. This sibling sequences is in accordance with the definition of a sibling sequence found in FIG. 12. Procedure 1710 finally presents an individual combined signature by outputting it according to specifications found in FIG. 13. The output individual combined signature is valid according to the characterization of validity found in FIG. 14, Equation 14.9.

Performance of Combined Signatures

From the operation of FIG. 17 we can consider the total performance of a combined digital signature device. From FIG. 15, it is clear that signal 1511 remains constant when only message selection 1505 changes. Signature extractor 1506 does no computationally intensive calculations, so efficient use of the signature making device occurs when the combined signature tree is computed once and all relevant signatures are extracted by cycling through valid message selections. Performance figures, therefore, should be calculated by considering the signature-making device as a batch processor.

A batch of computation consists of (1) a number of hash function computations for the parent nodes of a hash tree and (2) a single public key operation for the value of the root node of a combined signature tree. Signature extraction is but a small percentage of the total computational load and will be neglected here.

For a unit of time, instead of using seconds, we'll use the time it takes to calculate the hash value of a node. We'll call this one hash unit. At the end we'll take a ratio of the combined signature performance to the underlying public key performance, so exact time measurements would drop out anyway. The result we will obtain is a speedup factor over conventional public key signatures.

To do the estimate, we need to know how much time a public key operation takes in hash units. We'll take this ratio as 1000:1. In practice the public key operation is perhaps a little slower, but this will provide us with a conservatively-estimated speedup factor. The improvement over current practice is dramatic enough not to require a particularly precise estimate to demonstrate the speedup.

Each parent node takes a single hash function computation. For a combined signature tree of n nodes, there are n−1 total hash function computations. For simplicity of the exposition, we'll add in a gratuitous hash function and call the number of hash operations n. In addition, there is one public key signature for all of them. Total time to compute this tree is n+1000 hash units. The signature time per message, however, is the one that determines total performance. Signature time per message is 1+1000/n . For large values of n, then, the signature time per messages in only slightly larger than one hash unit. Normally, total performance is limited by the speed of the public key function. With a combined signature, total performance is limited by the speed of the hash function—quite a difference from the typical practice of cryptographic art.

The speedup ratio is equal to the time for the traditional method divided by the time for a single combined signature. The speedup formula with the current assumptions is 1000n/(n+1000). For small n, this speedup is approximately n. So for n=16, a quite small tree, the speedup is about 15.75, already more than an order of magnitude faster. For a medium-sized tree, say n=250, the speedup is 200; for n=4000, the speedup is 800. For large n, the total throughput speedup approaches its maximum value of 1000, or the ratio of one public key operation to a single hash function operations.

The previous estimate assumes that a single processor performs all the computations, so that no processing is done in parallel. When parallel processing can occur, speedups greater than those listed are possible.

FIG. 18. Flowchart for Verifying an Individual Combined Signature

FIG. 18 shows a flowchart for verifying an individual combined signature. The algorithm returns “valid” or “invalid” about the relationship between a signature, a message, and a public key, according to the characterization of extracted signature validity in Equation 14.9.

The procedure begins with a parsing procedure 1800, which parses an input of an individual combined signature 1801. Procedure 1800 detects whether signature 1801 was well-formed, and if it is, then constructs an internal representation of the data in the signature. Good-form test 1802 checks whether signature 1801 was well-formed; if not, signature rejection 1803 returns “invalid”.

Assuming the signature is well-formed, verification subtree construction 1804 creates a tree with a branch to root and any siblings of the nodes along that branch. Valid branch test 1806 then checks to see if the branch so constructed is a legal branch for a tree of the size stated in the signature. If not, signature rejection 1807 returns “invalid”.

Assuming the branch is valid, a root value calculation 1808 computes the branch of a verification tree, taking the value of a message 1809 as the value of a bottom branch node and using the stated sibling values from signature 1801. Calculation 1808 computes the values of the branch nodes, ending with a root node value.

A public key verification 1810 adds padding from signature 1801 to the root node value computed by root value calculation 1808. Verification 1810 then computes the value of the verification predicate for a public key 1811 against the padded value and the signature value from signature 1801. If the predicate is false, then signature rejection 1813 returns “invalid”. If the predicate is true, signature acceptance 1814 returns “valid”.

FIG. 19. Illustrative Timing Diagram of Asynchronous Operation

FIG. 19 shows an exemplary illustration of a timing diagram of a segment of operation of a signature-making device operating in its asynchronous mode.

The timing diagram, overall, is arranged in six row sections. The first row section illustrates an external sender of messages and signature requests. Each of the other five row sections represents a component of a device described in FIG. 15. Each component has a number of states. The timing diagram of FIG. 19 shows the states, activations of the states, and dependencies between them. Operation times were chosen to illustrate the pipeline behavior. The relative times of signatures, hashes, and extractions are not to scale.

The components are numbered according to the reference numerals that appear in FIG. 15; the name of each component appears underlined. The other labels in each component box are names of different states of the component. The horizontal dashed lines represent timelines of activation. A heavy bar designates an active state; a dashed line represents an inactive state. Each component has only one state active at a time. A more detailed description of these states appears below. The vertical and slanted lines between activation bars represent direct dependencies between activations; the end of an activation in one component triggers another activation, either internally or in a different component.

The numbered activations show the activations and signals relevant to making an individual combined signature on a first message input 1901. Input 1901 immediately (indicated by a vertical, non-slanted bar) invokes a queuing activation 1911 in message source 1500. Since constructor 1503 is idle when the queuing is finished, the end of activation 1911 immediately invokes a first tree increment activation 1921. The “constructing” state of constructor 1503 adds all ordinary tree nodes for the new index to its workspace and computes their values. First tree increment activation 1921 constructs just the leaf node, since it's the first node in an empty workspace.

Signature computation for message 1901 is blocked after the end of activation 1921, because root node signer 1504 is busy with a previous batch of messages (not shown). Meanwhile, other messages are arriving and being added to the current tree workspace of constructor 1503. A tenth message 1902 causes a tenth tree increment activation 1922. A signing tree activation 1930B ends during activation 1922, sending coordination signal 1930C to constructor 1503, instructing it to finish its processing on its workspace and to hand it off to signer 1504. Signal 1930C illustrates that signer 1504 is the bottleneck resource of a signing device; the goal is to keep signer 1504 in its “signing” state as much as possible. This goal allows latency through the device to be kept to a minimum.

Upon completion of activation 1922, a tree completion activation 1931A begins. At the end of activation 1922, the current tree workspace of constructor 1503 is emptied in preparation for a new batch of messages. Activation 1931 A completes the construction of the hash tree, by computing all the remaining values of nodes in the tree (which are exactly the non-ordinary nodes of the tree), which now has a known size since no more messages will be added to it. Activation 1931A then triggers a signing tree activation 1931B. At the end of activation 1931B, it sends a signal back as before (not shown) and also signals extractor 1506.

Extractor 1506 then begins an extraction activation 1941, which extracts a first signature from the completed combined signature tree and signals output 1507. Output 1507 then begins a sending activation 1951, which transmits an individual signature back to the original sender of message 1901. Meanwhile, extractor 1506 continues through its loop, extracting signatures for each message in the combined signature tree.

Latency though a Combined Signature Engine

The performance speedup of the present invention over traditional public key signature methods holds no matter whether the operation is synchronous or asynchronous. Overall, total performance generally governs an implementation decision for any system heavy with digital signatures. In certain situations, however, latency through a device is equally important a design constraint as performance, particularly for interactive protocols.

In these situations, it is important to understand the latency properties of a combined signature device. To estimate latencies, we will use a different unit of time than when we computed performance speedups. The natural unit of time is the “signature unit”, that is, the time it takes to compute a single private key operation. The asynchronous mode of operation has a free-running private key operation at its center in signer 1504. Whenever a message comes in, it is added to whatever workspace is current in constructor 1503. If the message comes into an empty workspace (as is the case with message 1901), it must wait one signature unit of time before its workspace enters signer 1504. If the message happens to be the last message in the workspace before the public key operation (as with message 1902), the delay is essentially zero (it's less than two hash units on average). Because messages arrive at random times throughout the cycle of the public key operation, the average time spent in constructor 1503 is one half of a signature unit. The delay through signer 1504 is one whole signature unit, plus a small bit extra for finishing the tree. Ignoring the small hash function overhead (which changes latencies by only about 2% even for enormously large trees of size 2¹⁸), the average latency through a combined signature engine is a little over one-and-a-half times the latency through a standard public key operation, and not more than twice that length of time.

This average latency is well within the bounds of suitability for any commercial protocol that would use digital signatures at all. Considering that current hardware designs for thousand-bit modular exponentiators are capable of more than 200 operations per second, latencies through a signature engine with a signer of this performance would yield maximum latency of about 10 ms. Even fast user interfaces can operate with response times of as long as 200 ms for major operations, so latency through a combined signature device is perfectly acceptable. Even though latency is slightly worse than existing practice, the difference is not commensurate with the throughput gain. Total enhanced performance more than pays off this small latency penalty.

State Machines for Pipeline Components

FIGS. 20-22 show state machines for the middle tree components of a signature pipeline: constructor 1503, singer 1504, and extractor 1506. Source 1500 and output 1507 are simple message queues of typical design, and so are not shown. The interaction of these state machines generates activity as illustrated in FIG. 19.

The state machine notation is UML. The top-level states match those of the FIG. 19 activation timelines. In some cases the top level states are compound states with internal structure. The large black dot in each state machine represents the state at startup. State transitions with labels represent event-driven transitions. State transitions without labels represent automatic transitions that occur automatically without an external trigger. All state transitions are made as soon as any running action has completed. Annotations of state transitions with square brackets are “guards”; they represent conditions that must be true before any transition may be taken.

FIG. 20. State Machine for a Hash Tree Constructor

FIG. 20 shows a state machine for constructor 1503. Constructor 1503 can receive a signal “message” from upstream source 1500; this signal includes a message to be incorporated into the current workspace and eventually signed. Constructor 1503 can also receive a signal “ready” from downstream signer 1504; this signal indicates that signer 1504 is ready to complete and sign another hash tree.

An initial state 2000 transitions to a waiting state 2002, which is the quiescent state while waiting for messages to arrive. An idle state 2001 consists of waiting state 2002 and a sending state 2003, and represents the state where constructor 1503 is not actively computing hash tree nodes. If the waiting state receives a “ready” signal from downstream, a ready transition 2011 fires to enter sending state 2003.

Upon receipt of a message from upstream, a message transition 2010 fires and enters a constructing state 2004. The entry action of state 2004 computes all new ordinary nodes after appending the message signal to the message sequence of the current workspace. If this computation completes without receiving a “ready” signal from downstream, an automatic transition 2012 fires and returns to waiting state 2002. If a ready signal is received during this computation, the ordinary node computation finishes, after which a ready transition 2013 fires to enter sending state 2003.

Sending state 2003 executes entry action “sendWorkspace”. If its workspace is empty, the entry action does nothing. Otherwise this action takes the current workspace and sends it downstream with a signal “workspace”. Then it clears its current workspace and discards the current message sequence, so that its workspace is empty. Upon having an empty workspace, an automatic transition 2012 fires to enter waiting state 2002.

FIG. 21. State Machine for a Root Signer

FIG. 21 shows a state machine for signer 1504. Signer 1504 can receive a signal “workspace” from upstream constructor 1503; this signal comes with a workspace for a hash tree with all ordinary nodes already computed.

An initial state 2100 transitions to a waiting state 2102. Upon entry into state 2102, its entry action sends a ready signal upstream to constructor 1503 to indicate that the signer is ready for a workspace. An idle state 2101 consists of waiting state 2102 and a sending state 2014, and represents the state where signer 1504 is not actively computing cryptographic values. Upon receipt of a workspace signal from upstream, a workspace transition 2110 fires to enter a completing state 2105. Note that all other transitions in this state machine are automatic.

The entry action of completing state 2105 computes any remaining non-ordinary nodes in the workspace. At end of this action, the root node of the hash tree has been computed and is ready to sign. State 2105 then automatically transitions to a signing state 2106. The entry action of state 2106 pads the root value and signs it. Upon completion of this signature, the combined hash tree is complete and ready for extraction. State 2106 then automatically transitions to sending state 2104.

The entry action of sending state 2104 sends a “tree” signal downstream to extractor 1506, accompanied by the now-complete combined signature tree of the current workspace of signer 1504. Upon sending the tree downstream, the action clears the current workspace in preparation for receipt of a new partial from upstream. Finally, state 2104 automatically transitions back to waiting state 2102.

FIG. 22. State Machine for a Signature Extractor

FIG. 22 shows a state machine for extractor 1506. Extractor 1506 can receive a signal “tree” from upstream signer 1504; this signal is a combined signature tree, completed and signed and ready for extraction.

An initial state 2200 transitions to an idle state 2201, which is the quiescent state while waiting for signer 1504 to complete. Upon receipt of a “tree” signal, a tree transition 2210 fires to enter an initializing state 2203. An extracting state 2202 consists of initializing state 2203, an extracting-next state 2204, and a sending state 2205. Upon entry, initializing state 2203 prepares the tree for individual signature extraction. State 2203 then automatically transitions to extracting-next state 2204.

State 2204 extracts the next signature from the tree and marks it as extracted. If the tree is empty and no further signatures can be extracted, an at-end transition 2211 fires to return to the idle state. If the tree is not empty, then there is an extracted signature ready to return to its original requestor; at this point a signature transition 2212 fires to enter sending state 2205. Sending state 2205 sends the extracted signature to an output queue, which transports the signature back as a return value. State 2205 then automatically transitions back to extracting-next state 2204. States 2204 and 2205 form a loop that extract all the signatures from a combined signature tree.

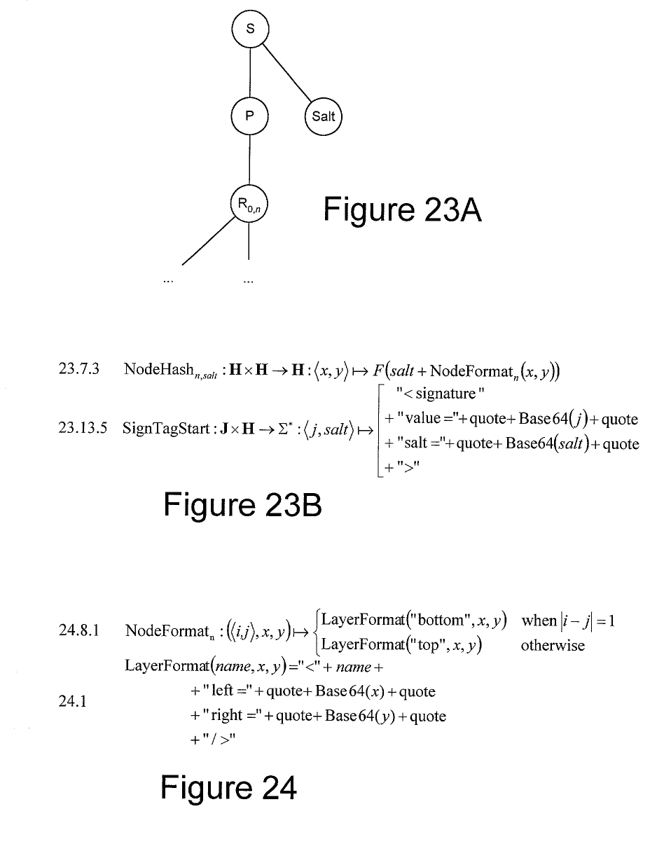

Description and Operation—Additional Embodiments, FIGS. 23A-26B

Variants in Hash Functions

The particular hash functions used in a preferred embodiment have a number of variants that also support the same object of prevention against tree extensions. While the variants are fairly straightforward to understand as differences from existing embodiments, it would tedious and certainly not concise to fully specify the variants in full. Therefore only certain essential differences from a preferred embodiment are noted; other differences will remain imputed. Figures for these variant embodiments contain extracts from exemplary diagrams and modification of significant equations of specification.

It will be appreciated that these variants are not all mutually exclusive. It is possible to employ combinations of these variations into further variants of a preferred embodiment.

FIGS. 23A-B. Salted Hash Functions

FIGS. 23A-B illustrate key differences in a variant embodiment that uses salted hash functions to prevent tree extensions. The principle of a salted hash function is that each tree uses its own unique hash function for node value computation. A family of hash functions is parameterized by a bit string called the “salt”. The salt is chosen in secret and only revealed outside a signature-making device after a tree is constructed. Because no opponent can know a salt value in advance, it is impossible to compute beforehand a leaf value that would cause a tree extension.

FIG. 23A shows a difference in the top few nodes of a combined signature tree for a salted hash variant. The difference is an extra node off the root signature node that holds a salt value. In a signature-making device as in FIG. 15, there must be a source for the value of a salt value just as there is one for the padding. This would require an extra input into root node signer 1504 (modification not shown).

FIG. 23B shows variant definitions of two important equations in the specification of the main embodiment. Equation 23.7.3 is a variant of Equation 7.3, providing a variant definition of a node hash function. In this case the node hash function is parameterized by a salt value. The salt is incorporated into the hash function definition by prepending it to the output of a formatting function. Note that Equation 23.7.3 does not define a position-dependent hash function. Prevention against tree extensions can be accomplished by techniques other than position-dependence.

Equation 23.13.5 is a variant of Equation 13.5, showing a variant definition of the signature tag in an extracted individual combined signature. The variant format substitutes the salt value for the size of the tree. A declared salt value allows a branch to root to be recomputed by the verifier. In this variant, verification may omit determination of branch shape validity, so the tree size is absent from the signature start tag.

FIG. 24. Distinctive Formatting of Bottom and Top Nodes

FIG. 24 illustrates key differences in a variant embodiment where bottom nodes, those whose children are leaves, are formatted differently than top nodes, which are all other parent nodes. The security of this technique requires that the length of the input message sequence is even, so that every leaf has a parent which is a bottom node. The principle of security here is that every branch from leaf to root has a single bottom node at the base and otherwise consists of top nodes. Since a signature making device always formats one node in any such chain with a bottom format, any tree extension would have more than one such bottom-formatted node. Such an extended sequence would not verify correctly, since it would be reconstructed with only a single bottom node.

Equation 24.8.1 is a modification of Equation 8.1, showing a variant specification for a node formatting function. A bottom node is one where the indices of the node only differ by one. Both alternatives in the definition call a function LayerFormat( ), differing only in the “top”/“bottom” designation they pass.

Equation 24.1 defines a function LayerFormat( ), which takes a name for the tag as a parameter. Otherwise the formatting function of Equation 24.1 is similar to those of Equations 8.2-3.

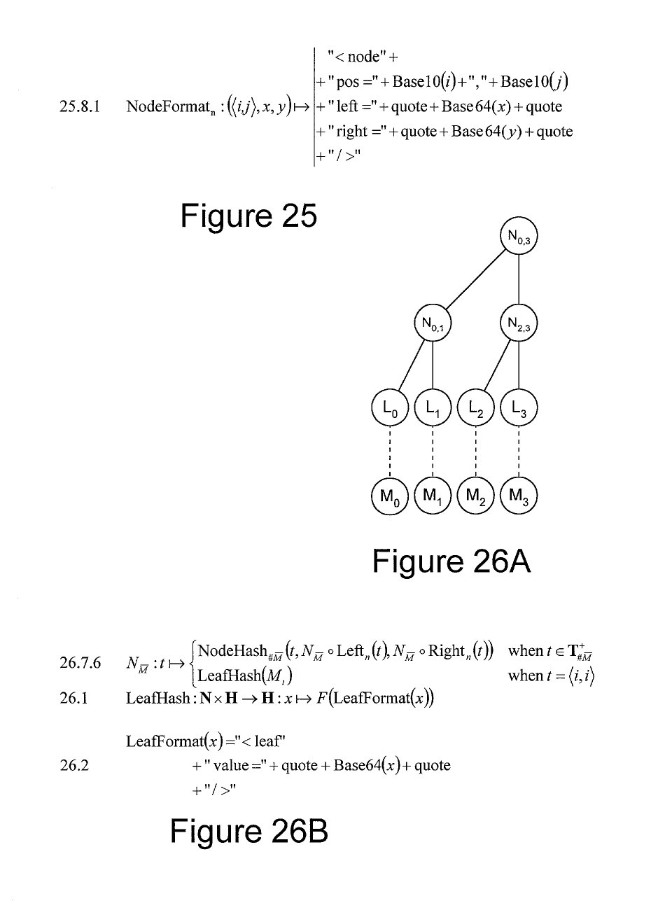

FIG. 25. Inclusion of Node Positions

FIG. 25 illustrates key difference in a variant embodiment where the node positions are directly incorporated into the result of a formatting function. Equation 25.8.1 is a variant of Equation 8.1. The node format adds a position parameter to the tag structure that directly outputs the node position.

An attempt at tree extension in this system would fall afoul of the interval-splitting property of binary trees. The nodes at the bottom of the tree can be split no farther than their two children. Since the verification procedure reconstructs a bottom branch node as a parent of two children, no chain longer than a single child (i.e. the original message) can verify correctly. Thus tree extensions are thwarted.

FIGS. 26A,B. Separate Layer of Leaf Nodes

FIGS. 26A,B illustrate key differences in a variant embodiment where the messages do not effectively form the leaf layer of the hash tree, but rather correspond one-to-one with a separate leaf layer. FIG. 26A shows an illustrative section of a left end of such a variant tree. Properly speaking, the messages are not part of the tree, and the correspondence between leaves and messages is shown with dashed lines.

FIG. 26B shows a variant definition of a node value function for a hash tree. Equation 26.7.6 is a variant of Equation 7.6. Instead of the values of the leaves being equal to the message values, as in Equation 7.6, they are the result of applying a distinct leaf hash function. Equation 26.1 contains a definition for such a leaf hash function that uses a standard construction. Equation 26.2 defines a formatting function for leaves.

As elsewhere, security for this variant relies on the branch reconstruction process, which computes the bottom leaf in the tree using a leaf hash function instead of a parent hash function. No tree extension is possible with this difference.

The variant of FIGS. 26A,B has one notable disadvantage. The construction of the hash tree requires twice as many hash operations as one where leaves are not individually hashed. This means a significant performance penalty, or else the requirement of additional circuitry to pick up the added hash computation load.

Description and Operation—Additional Embodiment, FIG. 27-29

Alternate Digital Signature Primitives and Variant Verification Techniques

While the ElGamal public key signature algorithm provides a suitable public key algorithm, any number of other public key signature algorithms could be substituted. A number of these are described in Chapters 19 and 20 of Bruce Schneier's book Applied Cryptography, 2^{nd} Edition. One notable such alternative is the DSS algorithm standardized by NIST. Indeed, since the combined signature is itself a public key signature algorithm, it could be used recursively as the digital signature for a top node.

Certain public key signature schemes have a special feature called “message recovery”. (See Schneier, page 497.) Verification for a scheme with message recovery contains a recovery function that extracts the original message from the signature. The verification predicate is the same for all schemes with message recovery—compare a given message against a message recovered from a signature with a public key. Verification with message recovery acts like an inverse to the corresponding signature operation. In particular, it allows alternate methods of verification for combined signature trees and extracted signatures.

The principle behind these alternate methods is that a prospective value for the root node of a hash tree can be computed in two ways, which can then be compared. The first way is the regular way, computing a hash tree root either from a message sequence or from a message and a sibling sequence. The second way is apply the recovery function of the scheme to the signature value of an individual combined signature. Then, instead of adding padding bits to the first value in preparation for applying a verification predicate, one can strip off the padding bits of the second value. At this point two prospective values can be compared, each in H. If they are equal, the signature verifies.

FIGS. 27-29 illustrate some of the major differences between this variant and a preferred embodiment. Showing a complete set of differences would not add clarity. Not all differences are shown; others must be inferred from the overall design principles of this specification.

It is worth noting that although the definition of combined signature tree validity in Equation 10.5 includes padding in the term N(P), this definition does not need to change for a variant using message recovery. Using message recovery does not mean that the padding is not used to make the signature, but rather a padding value is not required to verify it.

FIG. 27. Exemplary Illustration of a Variant Individual Combined Signature

FIG. 27 is a variant of FIG. 3, showing a variant signature start tag 2771T for an individual combined signature. The rest of the signature is as in FIG. 3. Note that the only difference is the absence of an analogue to padding attribute 372. Value attribute 2771 and size attribute 2773 are both present in essentially unchanged form. (The reference numerals are different because they are parts of different tag formats.) Since padding is not necessary for the verification step, it is omitted from the signature format.

FIG. 28. Exemplary Illustration of a Variant Pair of Verification Trees

FIG. 28 is a variant of FIG. 4, showing a first verification tree 2800 and a second verification tree 2801 whose roots match when a signature is valid. First tree has all the same structure as tree 400 except with no padding node. Second tree 2801 starts with a signature node 2871 at the bottom. A padding node 2861 is calculated by applying a message recovery operation to signature node 2871. A second hash tree root 2851 is the result of stripping padding bits from node 2861.

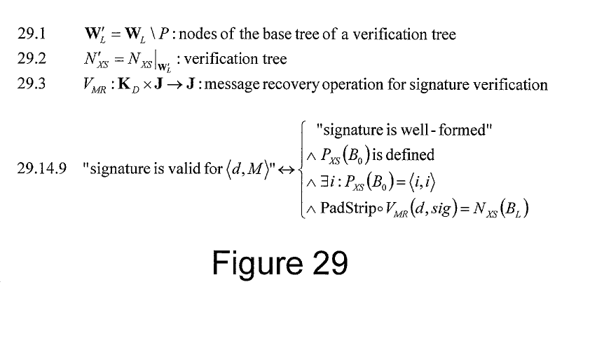

FIG. 29. Variant Verification Specifications

FIG. 29 shows variant equations from FIG. 14 concerning verification. Again, only key difference are noted in the illustration; other differences must be inferred. The extracted signature does not have a padding value, clearly.

Equation 29.1 is a variant of Equation 14.4 (but uses its definition); the verification tree omits the padding node of a preferred embodiment. Equation 29.2 is a variant of Equations 14.6-7. The verification tree of Equation 29.2 is the restriction of that of Equation 14.6 to the domain that omits the padding node. In other words, the verification tree drops the padding node. This matches the illustration in FIG. 28.

Equation 29.3 is a type specification of a message recovery operation of a public key signature scheme. The parameters are a public key and a signature value; the result is a message value.

Equation 29.14.9 is a variant of the definition of signature validity of Equation 14.9. The difference is in the fourth predicate. Instead of verifying a signature value against a computed padding node, a second prospective value of a hash tree root node is computed and then compared against the first. The second prospective value is result of the message recovery operation on the signature, followed by stripping off the padding bits.

Description and Operation—Alternate Embodiments

The reader will readily see that there are a number of alternate embodiments of the present invention not already described. Several such alternate embodiments are described below. These alternate embodiments represent only a few of many potential embodiments of the present invention. Furthermore, it would be impossible to characterize all such possible embodiments. The alternative embodiments below should be taken as exemplary of the variety of potential embodiments, not as limitations to them.

The signature-making and signature-verifying devices of the present invention can clearly be implemented as software machines, as hardware devices, as firmware within an embedded system, or as any combination of the above. While the signature-making process and the signature-verifying process have been described with common data structures, there is no reason that any single device could not implement a signature-making process, a signature-extraction process, or a signature-verifying process separately from each other, or in any combination.

Embodiments can be implemented as synchronous devices or asynchronous devices, or a combination of the two. One such combination of the two techniques would be to use a wrapper around an asynchronous device that presented a synchronous interface to a calling program. The independently-running stages in a pipelined signature-making device can be implemented either as autonomous processes or as threads, as a software environment supports.

A notable alternate embodiment of the present invention is as a coprocessor or add-on card for integration into a general-purpose server computer. Such a coprocessor could be implemented preferentially as an asynchronous, pipelined device to take advantage of the improved latency that such an architecture provides.

A further embodiment of the present invention is as a network-connected signature-making server. Such a device would function equivalently as a coprocessor, but would be attached through the network rather than through the computer's expansion bus. Such an embodiment as a network server would have expanded implementations of a message sequence source and a signature output. These expanded implementations would handle all the details of the network interface.

Conclusions, Ramifications, and Scope

The combined signature of present invention provides a extraordinarily high-performance mechanism for making public key signatures. Such a signature-making device can enable high-performance applications far in advance of the previous rate of progress of the art.

The present invention in its described embodiments contain a number of further advantages, including the following:

a) The algorithm for splitting signatures off from a tree is very efficient since it is simply an arrangement of data elements already computed.

b) A pipelined architecture for making combined signatures allows one to reduce latency by optimizing only the private key operation.

While the description of the several embodiments above contain many specificities, they should not be construed as limitations of the present invention, but rather as exemplifications of the embodiments. Many variations of the described embodiments are possible. Several such variations are described below.

Variations in Input

In the described embodiments, messages were taken as short, fixed-length bit strings. This choice was in order to more clearly expose an embodiment of the present invention as a signature-making server. In a network server embodiment, it is more efficient from a communication bandwidth and latency perspective to require the client to hash an original document down to a short, fixed-length message, which is then the subject of a signing request. Nevertheless, there is no need to require this property in embodiments of the present invention. A variant embodiment of the present invention accepts an entire document and hashes it inside a signature-making server.

Ordering of the messages in the tree need not be chronological. While the illustration of the pipelined operation shows messages being added to the tree in the order they were received, there is no essential requirement for this. For example, if certain signature requestors need higher priority than others, then there is utility in rearranging the input ordering.

An additional procedure to prevent against tree extensions is to attempt to parse an input message as parent node. If the node appears to be a signature format, the signature-maker refuses to sign. A disadvantage of this variation is that a signature device no longer will sign arbitrary bit strings.

Variations in Tree Structure

If protection against tree extension is not needed for a particular application, any tree structure is usable, even a randomly constructed one. Balanced trees yield shorter signatures on average, but certain applications may value other tree properties more than the length of a resulting extracted signature. One well-known such modification is to use ternary trees at each stage. A mixture of node arities is also possible. Even unary nodes, parents with a single child, could be used.

The mechanisms against tree extension in a preferred embodiment use a known-in-advance class of trees, the LBB-trees. Nevertheless, it will be appreciated that the anti-extension mechanisms work with many classes of trees.

The labeling convention of ordered pairs is convenient for describing positions of nodes in ordered trees, in particular in LBB-trees, but is not the only way of describing positions. Since the principle of position-dependent hash functions requires some dependence upon position, any other unambiguous encoding mechanism would work.

Variations in Hash Tree Computation

Similarly to the choice of public key signature algorithm, the selection of SHA-1 as the choice of cryptographic hash function is open to substitution as well. Chapter 18 of Applied Cryptography, 2^{nd} Edition by Bruce Schneier describes a number of suitable functions. One such alternative is RIPE-MD.

The position-dependent hash functions described for a preferred embodiment used an assumed class of tree. If multiple classes of tree are desirable for reasons external to a signature device, the top signature node could also contain an identifier for a particular class of ordered trees.

The position-dependent hash functions of a preferred embodiment take a position parameter in order to accomplish their position-dependence. Other means of attaining position dependence are possible. For example, root nodes, interior parent nodes, and leaf nodes are all distinguishable as separate positions with needing to know their exact position within a tree.

Variations in Top Signature Computation

The particular convention for padding the root node for private key signature admits of much variation. Different means of generating padding may have slightly different security analysis properties, but all are part of the scope of the present invention. Padding of all zeros, all ones, of random bits, of the results of a hash function applied to other signature data—all these methods are adequate for padding.

Padding may be eliminated from the extracted signature format when the procedure for determining the padding is deterministic and, if parameterized, based only on parameters shared by all signature verifiers. The hash tree root value and the tree size are the two of these available in a preferred embodiment. Constant padding, such as all zeros or a predefined constant value, also suffice.

In an embodiment where the bit lengths of the public key signature and the hash value of the root are of identical lengths, padding may be eliminated entirely.

Variations in Signature-Making

The component stages of a signature-making pipeline could also be replicated within a five-layer architecture, rather than a five sub-device architecture. For instance, it would be possible to have two or more public key signature devices in the signing layer of such a device. Such an architecture would be useful if it were needed to sign certain messages with more than one signature at time. Using a multiplicity of simultaneous signature operations allow multiple signatures without increasing the latency.

It is possible to change the division of labor between tree pre-computation in one stage of a pipeline and tree completion in a subsequent stage. Such alternate divisions could support a pipeline as whole layers. Messages could be variously assigned to a multiplicity of workspaces, for example.

Since private key operations are very predictable in their timing, a variation would anticipate the end of the private key operation and send the “ready” message in advance, in order to minimize the amount of time in the “idle” state.

In applications where joint signing is useful, another variation would allow multiple signatures by different private keys at the top in the signature node.

Variations in Signature Extraction

If a single requester has multiple signature requests that have been combined into a single combined signature tree, a variation of the signature extraction process would present in a single signature the union of a number of branches to root and the union of all their siblings. This compaction would alleviate bandwidth and storage requirements.

Another variation in signature format allows the various tags to be separated from each other and transmitted separately. By including more information in the pieces of signature format about sibling position and hash tree root value, the various tag components of a signature could be separated at extraction time and reassembled at verification time. In particular, the present invention allows for a public key signature on a hash tree root to be separated from hash tree branches and the hash tree itself. The packaging of the node representations is a matter of convenience of formatting.

Variations in Signature Verification

A signature verification device was described as taking a single input for verification. A performance enhancement is possible for a verification device that accepts multiple input signatures from the same tree. At minimum, the public key operation to compute a prospective hash tree root value would only need to be done once. In addition, certain computations of branch nodes, particularly those near the top, could be performed only once instead of multiple times.

Miscellaneous Variations

XML conventions for data representation have been used to describe signature formats, but any other means of formatting, such as ASN. 1, could be readily substituted. Even an ad hoc data formatting procedure could be used. The choice of data representation is enormously broad. The only noteworthy requirement in choice of data format is that the same representation be used for both for signature-making and signature-verifying; otherwise hash function results won't match up and signatures would not be verifiable.

The strings and characters described used ASCII. Any other character encoding, such as Unicode, could also be used.

Scope

Accordingly, the scope of the present invention should be determined not by the embodiments illustrated, but by the appended claims and their legal equivalents.

I claim:

1. A method for making a public key digital signature on a plurality of messages in an electronic system, comprising:
a) arranging said plurality of messages into an ordered sequence of messages,
b) constructing a hash tree from said sequence of messages, particularly computing a value of a root node of said hash tree,
c) preparing a private key for a digital signature operation, and
d) performing a cryptographic signature operation with said private key upon the value of said root node,
whereby a maker of said public key digital signature can simultaneously sign said plurality of messages.

2. The method of claim 1, wherein
a) said hash tree is constructed with a position-dependent hash function.

3. The method of claim 1, wherein
a) said hash tree is constructed with a salted hash function that incorporates a salt value,
whereby an outside party need not know said salt value in advance and thus would not be able to generate a tree extension.

4. The method of claim 1, wherein
a) the value of the leaves of said hash tree are taken as the results of a hash function applied to the values of said sequence of messages,
whereby a verifier may be able to determine that said public key digital signature was not generated as a tree extension.

5. The method of claim 1, further including
a) performing said cryptographic signature operation with padding added to the value of said root node,
whereby a verifier can verify a signature when using a cryptographic signature scheme without message recovery.

6. A method for making a public key digital signature on an individual message from out of a plurality of messages in an electronic system, comprising:
a) arranging said plurality of messages into an ordered sequence of messages,
b) constructing a hash tree from said sequence of messages, particularly computing a value of a root node of said hash tree,
c) preparing a private key for a digital signature operation,
d) performing a cryptographic signature operation with said private key upon the value of said root node, and
e) extracting said public key digital signature from a combination of said hash tree and from the results of said cryptographic signature operation,
whereby a verifier may be able to determine the verity of said public key digital signature against a combination comprising said individual message and a public key corresponding to said private key.

7. The method of claim 6, further including
a) incorporating a hash tree size into said public key digital signature, said hash tree size being the number of said plurality of messages,
whereby a verifier may be able to determine that said public key digital signature was not generated as a tree extension.

8. The method of claim 6, further including
a) incorporating a salt value into said public key digital signature, and wherein
b) said hash tree is constructed with a salted hash function that incorporates said salt value,
whereby a verifier may be able to determine that said public key digital signature was not generated as a tree extension.

9. The method of claim 6, further including
a) performing said cryptographic signature operation with padding added to the value of said root node, and
b) incorporating the value of said padding into said public key digital signature,
whereby a verifier can verify a signature when using a cryptographic signature scheme without message recovery.

10. A method for verifying a public key digital signature against an individual message and a public key in an electronic system, comprising:
a) parsing said public key digital signature and retrieving its signature data,
b) ascertaining that said signature data comprises a stated signature value and a stated sibling value-and-position sequence,
c) computing a hash tree branch comprising a leaf node and a root node, said hash tree branch being computed with the value of said individual message and with said stated sibling value-and-position sequence,
d) performing a verification operation on said stated signature value with the value of said root node and with said public key,
whereby a verifier can determine that said public key digital signature was generated from said individual message by a holder of a private key corresponding to said public key.

11. The method of claim 10, wherein
a) said stated signature value comprises a stated cryptographic signature and a stated padding value, and further including
b) performing said verification operation with said stated padding value added to the value of said root node,
whereby a verifier can verify a signature when using a cryptographic signature scheme without message recovery.

12. The method of claim 10, wherein
a) said stated signature value comprises a stated cryptographic signature, and
b) said verifying step uses a cryptographic signature scheme with message recovery.

13. The method of claim 10, wherein
a) said hash tree branch is computed with a position-dependent hash function.

14. The method of claim 10, further including
a) ascertaining that said signature data comprises a hash tree size,
b) determining a tree representative of a tree family, said tree representative having said hash tree size, and
c) determining whether or not the shape of said hash tree branch is a valid branch of said tree representative,
whereby a verifier can determine that said public key digital signature was not generated as a tree extension.

15. The method of claim 10, further including
a) ascertaining that said signature data comprises a salt value, and wherein
b) the hash function used to compute said hash tree branch is a salted hash function that incorporates said salt value.
whereby a verifier can have an assurance that said public key digital signature was not generated as a tree extension.

16. The method of claim 10, wherein
a) the value of the leaf of said hash tree branch is taken as the result of a hash function applied to the value of said individual message,
whereby a verifier can have an assurance that said public key digital signature was not generated as a tree extension.

17. A signature data structure embodied in a computer-readable medium, comprising:
a) a value-and-position sequence, said value-and-position sequence comprising a sibling sequence for a branch from a leaf to the root of a hash tree, and
b) a public key signature,
whereby a signature maker has the ability to store and to transmit said signature data structure comprising a public key digital signature.

18. The signature data structure of claim 17, further including
a) a padding value,
whereby a verifier can verify a signature when using a cryptographic signature scheme without message recovery.

19. The signature data structure of claim 17, further including
a) a tree size value,
whereby a verifier can determine that said public key digital signature was not generated as a tree extension.

20. The signature data structure of claim 17, further including
a) a salt value,
whereby a verifier can verify a signature when said signature was generated with a salted hash function.
